(19) United States
(12) Patent Application Publication
(10) Pub. No.: US 2022/0180698 A1
(43) Pub. Date: Jun. 9, 2022

(54) GAME APPARATUS

(71) Applicant: KONAMI AMUSEMENT CO., LTD., Ichinomiya-shi (JP)

(72) Inventors: Yoshiya SHIMBATA, Aichi (JP); Seiya YAMANE, Aichi (JP); Shinya SUGA, Aichi (JP)

(73) Assignee: KONAMI AMUSEMENT CO., LTD., Ichinomiya-shi (JP)

(21) Appl. No.: 17/681,485

(22) Filed: Feb. 25, 2022

Related U.S. Application Data
(63) Continuation of application No. PCT/JP2020/031649, filed on Aug. 21, 2020.

(30) Foreign Application Priority Data
Aug. 27, 2019 (JP) 2019-154754

(51) Int. Cl. G07F 17/32

(52) U.S. Cl. CPC G07F 17/3216; G07F 17/3297

(57) ABSTRACT

A game apparatus includes a first space to which a game object is supplied, a plurality of urging bodies arranged spaced apart from each other in the first space and configured to urge the game object, and a second space for carrying out a first lottery using the game object. In the game apparatus, a holding state changes to a communication state, the holding state is a state in which movement of the game object from the first space to the second space is blocked, and the communication state is a state in which the game object urged by the plurality of urging bodies move from the first space to the second space.

### CROSS REFERENCE TO RELATED APPLICATION

This Application is a Continuation Application of PCT Application No. PCT/JP2020/031649, filed Aug. 21, 2020, and is based on, and claims priority from, Japanese Patent Application No. 2019-154754, filed Aug. 27, 2019, the entire contents of each of which are incorporated herein by reference.

### BACKGROUND OF THE INVENTION

### Field of the Invention

The disclosure relates to a game apparatus.

### Description of Related Art

There has been conventionally proposed in the art of game apparatuses to use game objects such as spherical objects. For example, Japanese Patent No. 4399470 discloses a game machine with a game table on which spherical objects roll. On the game table, lottery mechanisms and an urging body are arranged. Each of the lottery mechanisms strikes the spherical objects that come into contact with the lottery mechanism. The urging body urges the spherical objects toward a surrounding area of the urging body. The spherical objects are supplied on a surface of the game table when a player wins an electronic lottery. Recently, game apparatuses are required to have an effective direction using game objects.

### SUMMARY

In view of the circumstances described above, an object of the present disclosure is to realize an effective direction using a game object.

In one aspect, a game apparatus includes a first space to which a game object is supplied, a plurality of urging bodies arranged spaced apart from each other in the first space and configured to urge the game object, and a second space for carrying out a first lottery using the game object. In the game apparatus, a holding state changes to a communication state. The holding state is a state in which movement of the game object from the first space to the second space is blocked. The communication state is a state in which the game object urged by the plurality of urging bodies moves from the first space to the second space.

### BRIEF DESCRIPTION OF THE DRAWINGS

FIG. 1 is a plan view illustrating a configuration of a game apparatus according to a first embodiment.

FIG. 2 is a block diagram illustrating a functional configuration of the game apparatus.

FIG. 3 is a plan view illustrating a configuration of an amusement device.

FIG. 4 is a perspective view illustrating the configuration of the amusement device.

FIG. 5 is a block diagram illustrating functions of a controller.

FIG. 6 is a flowchart illustrating a specific procedure of a usual game processing.

FIG. 7 is a diagram for explaining lottery events.

FIG. 8 is a plan view illustrating a configuration of a first lottery device.

FIG. 9 is a cross-sectional view taken along line a-a in FIG. 8.

FIG. 10 is a side view illustrating an urging body.

FIG. 11 is a diagram for explaining movement of a movable body.

FIG. 12 is a flowchart illustrating a specific procedure of a first control processing.

FIG. 13 is a diagram illustrating a configuration located between the first lottery device and a second lottery device.

FIG. 14 is a plan view illustrating a configuration of the second lottery device.

FIG. 15 is a cross-sectional view taken along line b-b in FIG. 14.

FIG. 16 is a diagram illustrating an outline of each lottery element.

FIG. 17 is a cross-sectional view illustrating a configuration of a unit display portion.

FIG. 18 is a flowchart illustrating a specific procedure of a second control processing.

FIG. 19 is a flowchart illustrating the specific procedure of the second control processing.

FIG. 20 is a diagram for explaining reward history data.

FIG. 21 is a schematic diagram illustrating a reward image.

FIG. 22 is a flowchart illustrating a specific procedure of a display control processing.

FIG. 23 is a diagram for explaining the giving of a transitional reward in a first lottery event in a second embodiment.

FIG. 24 is a diagram for explaining an opening of an amusement device according to a modification.

FIG. 25 is a flowchart illustrating a specific procedure of display control processing according to another modification.

FIG. 26 is a schematic diagram illustrating a reward image according to yet another modification.

FIG. 27 is a schematic diagram illustrating reward history data according to yet another modification.

FIG. 28 is a flowchart illustrating a specific procedure of a display control processing according to a modification.

### DETAILED DESCRIPTION

Embodiments according to the disclosure are described with reference to the drawings. The embodiments described below include various technical limitations. The scope of the disclosure is not limited to the embodiments described below.

### First Embodiment

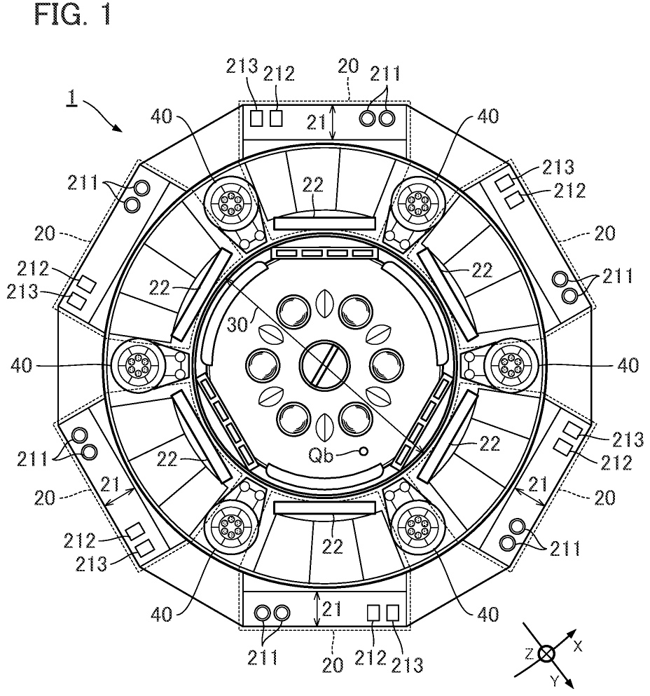

FIG. 1 is a plan view illustrating a configuration of a game apparatus 1 according to a first embodiment. The game apparatus 1 is an amusement system installed in an amusement facility, for example. The amusement facility is an entertainment facility, such as an amusement arcade or a casino, or a commercial facility such as a shopping center, for example. The game apparatus 1 provides games to players, who are users of the game apparatus 1, in the amusement facility. The game apparatus 1 may be a single apparatus or a system that is a combination of apparatuses.

A player plays a game by using one or more game mediums. A game medium is a tangible or intangible value medium used in the game. The tangible game medium is, for example, a token coin (a medal), a coin, a bill, or a ticket. The intangible game medium is, for example, an electronic medal, a credit or a point. Electronic data indicative of a quantity of the intangible game mediums is stored on a recording medium such as an IC card. The player plays the game by using one or more game mediums, and may obtain game mediums of which the quantity varies in accordance with the progress of the game, as rewards. The type of game medium used to play the game may be the same as, or different from, the type of game medium given to the player as rewards. The use of game mediums is referred to as input or spending (or betting) of the game mediums, and the giving of game mediums is referred to as paying out of the game mediums.

The player may acquire the game mediums to be used in the game in exchange for value mediums different than the game mediums. For example, in exchange for value mediums of which the quantity is a predetermined quantity, the player acquires the game mediums such as credits to be used in the game. The value mediums may be token coins, coins (bills) or electronic money. As will be understood from the above description, the type of game medium used in the game, the type of value medium spent to acquire (for example, purchase) the game mediums, and the type of game medium given to the player as rewards may be the same as, or different from, each other.

As illustrated in FIG. 1, the game apparatus 1 according to the first embodiment includes a plurality of amusement devices 20, a first lottery device 30, and a plurality of second lottery devices 40. In the following descriptions, a direction along a circumference of a virtual circle centered at a central axis of the game apparatus 1 along a vertical direction is referred to as an “X direction”, and a direction along a radius of the virtual circle is referred to as a “Y direction.” A direction perpendicular to an X-Y plane is referred to as a “Z direction.” The Z direction corresponds to the vertical direction. The X direction (circumferential direction) is an example of a “first direction.” The Y direction (radial direction) is an example of a “second direction.”

Each amusement device 20 is a unit for a player to play a particular game (hereinafter referred to as a “usual game”). Each amusement device 20 is referred to as a “station.” The plurality of amusement devices 20 are arranged along the X direction so as to surround the first lottery device 30. Usual games are progressed in parallel in the plurality of amusement devices 20 by different players. The second lottery device 40 is arranged for each of the amusement devices 20. The second lottery device 40 may be arranged for each pair of two amusement devices 20 next to each other in the X direction. In other words, the second lottery device 40 may be shared by two different players.

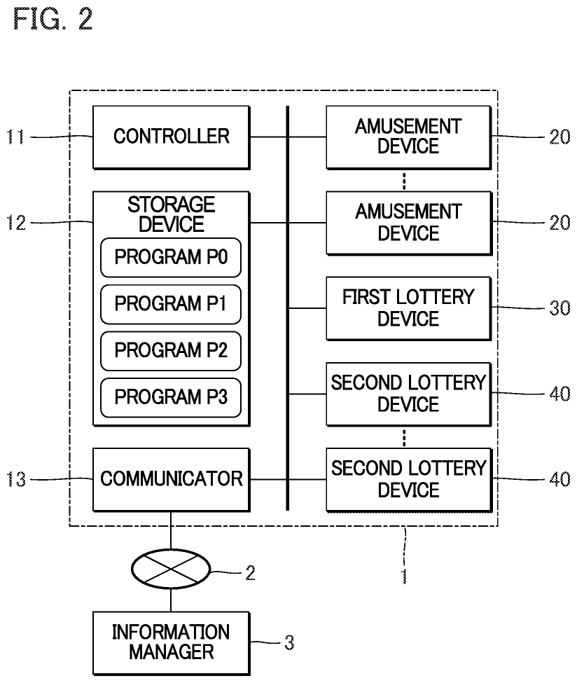

FIG. 2 is a block diagram illustrating a functional configuration of the game apparatus 1. As illustrated in FIG. 2, the game apparatus 1 includes a controller 11, a storage device 12, and a communicator 13 in addition to the plurality of amusement devices 20, the first lottery device 30, and the plurality of second lottery devices 40. The controller 11 is, for example, at least one processor that controls each of elements of the game apparatus 1. Specifically, the controller 11 includes at least one processor such as a central processing unit (CPU), a graphics processing unit (GPU), a digital signal processor (DSP), a field programmable gate array (FPGA), or an application specific integrated circuit (ASIC). The controller 11 according to the first embodiment controls respective operations of the respective amusement device 20, the first lottery device 30, and the respective second lottery devices 40.

The storage device 12 is at least one memory that stores programs executed by the controller 11 and various data used by the controller 11. For example, the storage device 12 includes a known recording medium such as a semiconductor recording medium and a magnetic recording medium. The storage device 12 may include a combination of different types of recording mediums. The storage device 12 according to the first embodiment stores a program P0 for controlling each of the amusement devices 20, a program P1 for controlling the first lottery device 30, a program P2 for controlling the second lottery devices 40, and a program P3 for controlling displaying images.

The communicator 13 communicates with other devices via a communication network 2, such as the Internet, for example. The communicator 13 according to the first embodiment communicates with the information manager 3. The information manager 3 is a server that stores data to be used in the game apparatus 1.

### A: Amusement Device 20

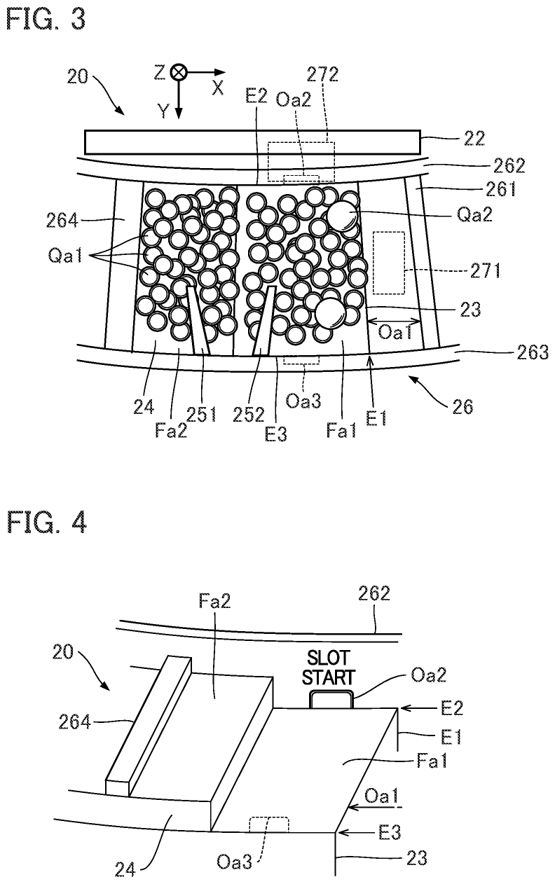

FIG. 3 is a plan view illustrating a configuration of any of the amusement devices 20, and FIG. 4 is a perspective view illustrating the configuration of the amusement device 20. The amusement device 20 according to the first embodiment is a mechanism for providing the usual game to the player. The usual game according to the first embodiment is a pusher game. As illustrated in FIGS. 1 and 3, the amusement device 20 includes an operation panel 21, a display 22, a fixed table 23, a movable table 24, a feeder 251, a feeder 252, a support structure 26, a detector 271, and a detector 272. The display 22 displays images instructed by the controller 11. For example, the display 22 includes a display panel, such as a liquid crystal display panel or an organic EL display panel.

The operation panel 21 is an input device for receiving instructions from the player. Specifically, as illustrated in FIG. 1, the operation panel 21 includes operation elements 211, a receiver 212, and a payout portion 213. Each operation element 211 is an operation button operable by the player. The receiver 212 accepts inputs of the game mediums. For example, the receiver 212 includes a slot for receiving tangible game mediums such as token coins, or a reading circuit for acquiring intangible game mediums such as credits from a recording medium such as an IC card. The payout portion 213 pays out one or more rewards given to the player. For example, the payout portion 213 includes a payout port for paying out tangible game mediums such as token coins, or a writing circuit for writing intangible game mediums such as credits onto the recording medium.

The fixed table 23 is a plate-shaped member arranged horizontally or almost horizontally. Specifically, the fixed table 23 is a plate-shaped member formed in a shape of an arc along the X direction. The movable table 24 is a three-dimensional structure (a so-called a pusher table) that reciprocates along an axis along the X direction on a surface (hereinafter referred to as a “placing surface”) Fa1 of the fixed table 23. Directions along the axis along the X direction in the amusement device 20 corresponds to right and left directions of the player, and are an example of “first directions.” The movable table 24 is an example of a “movable body.”

The feeder 251 is a mechanism for feeding game objects Qa1 toward a surface (hereinafter referred to as a “placing surface”) Fa2 of the movable table 24. Each game object Qa1 according to the first embodiment is a token coin in a disk shape. For example, the feeder 251 may feed, as the game objects Qa1, the game mediums used by the player. The feeder 251 may feed, as the game objects Qa1, game mediums of which the quantity corresponds to the intangible game mediums used by the player. A direction in which the feeder 251 feeds the game object Qa1 and a point in time at which the feeder 251 feeds the game object Qa1 is each controlled, for example, in accordance with instructions from the player to the operation element 211.

The support structure 26 is a structure supporting each element of the amusement device 20. Specifically, the support structure 26 includes a first wall portion 261, a second wall portion 262, a third wall portion 263, and a fourth wall portion 264. The first wall portion 261 is a portion extending in the Y direction at a position spaced from a first peripheral edge E1 of the placing surface Fa1. The first peripheral edge E1 is a peripheral edge of the placing surface Fa1. The first peripheral edge E1 faces the first wall portion 261. In other words, the first peripheral edge E1 is a right edge or a left edge of the placing surface Fa1 when viewed by the player. As illustrated in FIGS. 3 and 4, an opening Oa1 that is long in the Y direction is formed between the first peripheral edge E1 of the placing surface Fa1 and the first wall portion 261.

The second wall portion 262 is a wall portion protruding from the placing surface Fa1 along a second peripheral edge E2 of the placing surface Fa1. The second peripheral edge E2 is a peripheral edge of the placing surface Fa1. Specifically, the second peripheral edge E2 is an inner peripheral edge of the placing surface Fa1. The second peripheral edge E2 faces the first lottery device 30. In other words, when a side of the amusement device 20 facing the player is referred to as the “front side” and the opposite side is referred to as the “rear side,” the second peripheral edge E2 is a rear edge of the placing surface Fa1. The third wall portion 263 is a wall portion protruding from the placing surface Fa1 along a third peripheral edge E3 of the placing surface Fa1. The third peripheral edge E3 is a peripheral edge of the placing surface Fa1. Specifically, the third peripheral edge E3 is an outer peripheral edge of the placing surface Fa1. The third peripheral edge E3 faces the player of the amusement device 20. In other words, the third peripheral edge E3 is a front edge of the placing surface Fa1. As will be understood from the above description, the movable table 24 reciprocates along the axis in the X direction in a space between the second wall portion 262 and the third wall portion 263. The second wall portion 262 is positioned on a rear side of the fixed table 23 when viewed by the player, and the third wall portion 263 is positioned on a front side of the fixed table 23 when viewed by the player.

The fourth wall portion 264 is a portion extending in the Y direction on the placing surface Fa2 of the movable table 24. That is, the fourth wall portion 264 faces the placing surface Fa2. A distance between the placing surface Fa2 and the second wall portion 262 is less than the minimum size of an external form of the game object Qa1 (for example, the thickness of the game object Qa1).

As illustrated in FIG. 3, a large number of game objects Qa1 are stacked tightly on the placing surface Fa1 of the fixed table 23 and on the placing surface Fa2 of the movable table 24. The game objects Qa1 on the placing surface Fa2 of the movable table 24 are pressed in the X direction by the fourth wall 264 in response to movement of the movable table 24 in a direction opposite to the X direction. The game objects Qa1 on the placing surface Fa2 are sequentially moved in the X direction in response to the fourth wall 264 pressing the game objects Qa1. Accordingly, game objects Qa1 near the periphery of the movable table 24 fall from the placing surface Fa2 onto the placing surface Fa1 of the fixed table 23. Game objects Qa1 on the placing surface Fa1 are sequentially moved in the X direction in response to pressure by the movable table 24 moving in the X direction. Accordingly, game objects Qa1 near the first peripheral edge E1 of the fixed table 23 fall from the first peripheral edge E1 into the opening Oa1.

The detector 271 is a sensor that detects the game objects Qa1 falling from the first peripheral edge E1 of the placing surface Fa1 into the opening Oa1. The player is given rewards in accordance with the number of the game objects Qa1 detected by the detector 271. For example, the payout portion 213 pays out, as rewards, the game mediums of which the quantity varies in accordance with the number of the game objects Qa1 detected by the detector 271.

As illustrated in FIGS. 3 and 4, the second wall portion 262 has an opening Oa2. The opening Oa2 is an opening along the second peripheral edge E2 of the placing surface Fa1. The opening Oa2 is formed at a position at which the placing surface Fa1 and the second wall portion 262 intersect. Therefore, the opening Oa2 is visible to the player. The opening Oa2 may be formed on the placing surface Fa1. When game objects Qa1 on the placing surface Fa1 are pressed by the movable table 24, game objects Qa1 near the second peripheral edge E2 move in a direction opposite to the Y direction and then fall from the placing surface Fa1 into the opening Oa2.

The detector 272 is a sensor (so-called a chucker) that detects game object Qa1 falling from the second peripheral edge E2 of the placing surface Fa1 into the opening Oa2. The detector 272 is arranged in a direction opposite from the Y direction when viewed from the placing surface Fa1. For example, the detector 272 includes an optical sensor or a contact sensor. The optical sensor detects game objects Qa1 that fall into the opening Oa2 and that prevent a light receiving element from receiving irradiation light. The contact sensor detects contacts between game objects Qa1 and a detection body arranged directly below the opening Oa2.

In the first embodiment, a lottery (hereinafter referred to as a “usual lottery”) is carried out based on the detector 272 detecting a game object Qa1. The usual lottery according to the first embodiment is an electronic lottery to select a wining or a losing (a non-winning, a blank) of the player in accordance with probabilities. For example, the usual lottery may be a video slot to determine whether the player wins or loses in accordance with a combination of patterns including a pattern selected, for each of reels, from candidates on the basis of probabilities.

As illustrated in FIGS. 3 and 4, the third wall portion 263 has an opening Oa3. The opening Oa3 is an opening along the third peripheral edge E3 of the placing surface Fa1. Administrators of the game apparatus 1 (for example, employees of the amusement facility) may adjust the size of the opening Oa3 as appropriate. The third wall portion 263 is positioned between the opening Oa3 and the player, and therefore, the opening Oa3 is invisible to the player. The opening Oa3 may be formed on the placing surface Fa1. When game objects Qa1 on the placing surface Fa1 are pressed by the movable table 24, game objects Qa1 near the third peripheral edge E3 move in the Y direction and then fall from the placing surface Fa1 into the opening Oa3. Although the game objects Qa1 falling into the opening Oa1 contribute to the rewards and the game objects Qa1 falling into the opening Oa2 contribute to the usual lottery, the game objects Qa1 falling into the opening Oa3 contribute to neither the rewards nor the usual lottery (so-called “out zone”). Therefore, a ratio (a payout rate) of the quantity of game mediums used by the player in the usual game to the quantity of rewards given to the player is adjustable in accordance with the size of the opening Oa3 at the third peripheral edge E3.

Conventional pusher games give rewards in accordance with game objects Qa1 that fall from the first peripheral edge E1 in the directions in which the movable table 24 reciprocates. In other words, a basic object of the pusher game is to drop the game objects Qa1 from the first peripheral edge E1. In view of the above description, even if game objects Qa1 fall from the second peripheral edge E2 in a direction intersecting the directions in which the movable table 24 reciprocates, game objects Qa1 falling from the second peripheral edge E2 do not usually contribute to rewards. In contrast to the usual circumstances described above, in the first embodiment, the usual lottery is carried out based on a game object Qa1 falling from the second peripheral edge E2 in the direction opposite to the Y direction intersecting the directions in which the movable table 24 reciprocates. As will be understood from the above description, the first embodiment includes a feature in which the “out zone” in the conventional pusher games contribute to the player's advantage (acquisition of the right to the usual lottery). In the first embodiment, the size of the opening Oa2 for the usual lottery is fixed, while the size of the opening Oa3 that does not contribute to rewards is adjustable. Therefore, it is possible to adjust the payout rate without excessively affecting game performance of the usual game (in particular, opportunity to start the usual lottery).

The feeder 252 in FIG. 3 feeds game objects Qa2 onto the placing surface Fa1 in response to the player winning the usual lottery. The game object Qa2 is, for example, a spherical body of which an outer diameter is greater than that of the game object Qa1. The game objects Qa2 on the placing surface Fa1 each move with the game objects Qa1 toward the first peripheral edge E1 under pressure by the movable table 24, and finally fall from the first peripheral edge E1 of the placing surface Fa1 into the opening Oa1. On the other hand, the size of the game object Qa2 is greater than the size of the opening Oa2 along the second peripheral edge E2. Therefore, the game object Qa2 does not fall from the second peripheral edge E2 into the opening Oa2. Similarly, the size of the game object Qa2 is greater than the size of the opening Oa3 along the third peripheral edge E3. Therefore, the game object Qa2 does not fall from the third peripheral edge E3 into the opening Oa3. The shapes of the game object Qa1 and the game object Qa2 are freely selected.

To prevent the game object Qa2 from falling into the opening Oa2 or the opening Oa3, protrusions may be arranged on an inner wall surface of the second wall portion 262 or on an inner wall surface of the third wall portion 263. For example, the protrusions may be arranged on the second wall portion 262 or the third wall portion 263 such that a distance between the placing surface Fa1 and the protrusions is greater than the height of the game object Qa2 and is less than the height of the game object Qa1. According to the configuration described above, the protrusions prevent the game object Qa2 from falling into the opening Oa2 or the opening Oa3. Therefore, it is possible to freely select the size of the opening Oa2 or the opening Oa3. Consequently, the above configuration has an advantage in that the payout rate is easily adjustable by adjustment of the size of the opening Oa3, for example.

Detector 271 detects the game objects Qa2 falling from the placing surface Fa1 into the opening Oa1, in addition to the game objects Qa1 falling into the opening Oa1. In response to the number N of the game objects Qa2 having fallen into the opening Oa1 reaching a predetermined value N (for example, Nth=3), a lottery event starts to allow the player to acquire special rewards (hereinafter referred to as “special rewards”). The lottery event is a game event using the first lottery device 30 and the second lottery device 40.

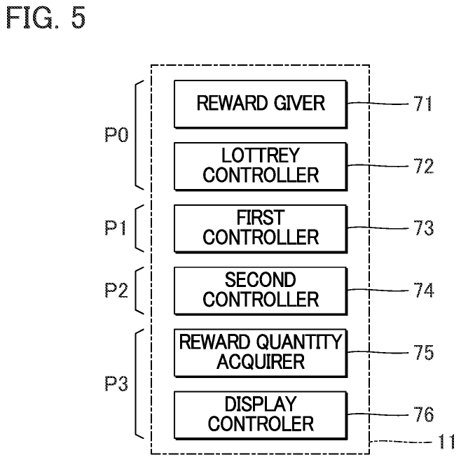

FIG. 5 is a block diagram illustrating functions of the controller 11. The controller 11 realizes functions (a reward giver 71 and a lottery controller 72) relating to the usual game by executing the program P0 stored in the storage device 12. The reward giver 71 gives the player rewards in accordance with the game objects Qa1 falling from the first peripheral edge E1 of the placing surface Fa1 into the opening Oa1. The lottery controller 72 carries out the usual lottery in response to the detector 272 detecting the game object Qa1 falling from the second peripheral edge E2 of the placing surface Fa1 into the opening Oa2.

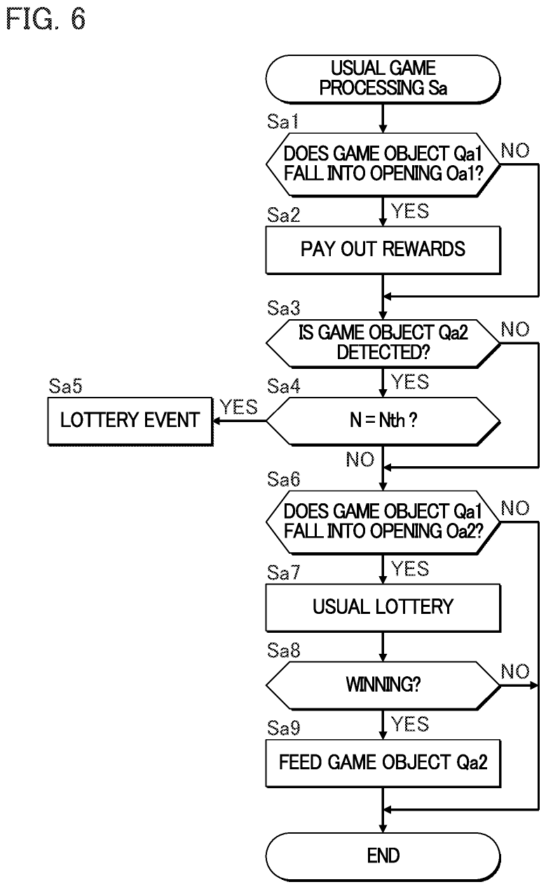

FIG. 6 is a flowchart illustrating a specific procedure of a processing (hereinafter referred to as a “usual game processing”) Sa executed by the controller 11 for the usual game. For example, the usual game processing Sa is repeatedly executed in response to interruptions that occur at predetermined time intervals.

In response to a start of the usual game processing Sa, the reward giver 71 determines whether the detector 271 detects the game object Qa1 (Sa1). In other words, the reward giver 71 determines whether the game object Qa1 falls from the first peripheral edge E1 of the placing surface Fa1 into the opening Oa1. When the detector 271 detects the game object Qa1 (Sa1: YES), the reward giver 71 pays out a predetermined quantity of game mediums from the payout portion 213 as rewards (Sa2). In other words, a predetermined quantity of rewards are given to the player each time the game object Qa1 falls from the first peripheral edge E1. When the detector 271 does not detect the game object Qa1 (Sa1: NO), no rewards are given to the player.

The reward giver 71 determines whether the detector 271 detects the game object Qa2 (Sa3). In other words, the reward giver 71 determines whether the game object Qa2 falls from the first peripheral edge E1 of the placing surface Fa1 into the opening Oa1. When the detector 271 detects the game object Qa2 (Sa3: YES), the reward giver 71 adds 1 to N indicative of the number of game objects Qa2 that have fallen from the first peripheral edge E1, and then determines whether N reaches the predetermined value Nth (Sa4). When N reaches the predetermined value Nth (Sa4: YES), the lottery event using the first lottery device 30 and the second lottery device 40 is started (Sa5). With the start of the lottery event, the N indicative of the number of game objects Qa2 is initialized to zero.

On the other hand, when the detector 271 does not detect the game object Qa2 (Sa3: NO), or when the number N of game objects Qa2 does not reach the predetermined value Nth (Sa4: NO), the lottery controller 72 determines whether the detector 272 detects the game object Qa1 (Sa6). In other words, the lottery controller 72 determines whether the game object Qa1 falls from the second peripheral edge E2 of the placing surface Fa1 into the opening Oa2. When the detector 272 detects the game object Qa1 (Sa6: YES), the lottery controller 72 carries out the usual lottery (Sa7). Specifically, the lottery controller 72 causes the display 22 to display a game image representative of the usual lottery, and then determines by lottery whether the player wins or loses the usual lottery. When the player wins the usual lottery (Sa8: YES), the lottery controller 72 causes the display 22 to display an image representative of the winning of the player, and then controls the feeder 252 to feed the game object Qa2 on the placing surface Fa1 (Sa9). On the other hand, when the player loses the usual lottery (Sa8: NO), the usual game processing Sa ends without feeding the game object Qa2.

As described above, in the first embodiment, rewards are given to the player when the game object Qa1 falls from the first peripheral edge E1 of the placing surface Fa1, which is located in the X direction. The usual lottery is carried out when the game object Qa1 falls from the second peripheral edge E2 located in the direction opposite to the Y direction. Accordingly, compared with a configuration in which the objective of a game is only to move game objects Qa1 in the X direction (for example, a configuration in which the game object Qa1 falling from the second peripheral edge E2 does not contribute to rewards), it is possible to diversify the usual game. Furthermore, the detector 272 is arranged in the direction opposite to the Y direction when viewed from the placing surface Fa1, which has an advantage in that the size of the amusement device 20 in the X direction can be easily reduced as compared with a configuration in which the detector 272 is arranged at a position in the X direction from the placing surface Fa1.

The directions along the axis along the X direction in the first embodiment are the right and left directions when viewed from the player. In other words, the movable table 24 reciprocates along the right and left directions when viewed from the player. Therefore, compared with a configuration in which the movable table 24 reciprocates along front and back directions when viewed from the player, the first embodiment has an advantage of reducing the depth required for the placing surface Fa1. Furthermore, the second peripheral edge E2 is the rear end of the placing surface Fa1, which has an advantage in that the second peripheral edge E2 is easily visible to the player.

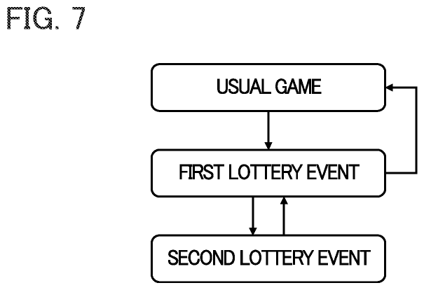

FIG. 7 is a diagram for describing lottery events. The lottery events according to the first embodiment include a first lottery event and a second lottery event. The second lottery event is a game event to determine by lottery whether to give special rewards to a player. The first lottery event is a game event to determine by lottery whether to start the second lottery event. The special rewards are, for example, many game objects Qa1 (a so-called “jackpot”). Specifically, many game objects Qa1 given to the player as special rewards are fed onto the placing surface Fa1 of the fixed table 23 and onto the placing surface Fa2 of the movable table 24. However, the special rewards are not limited to the above rewards, and a method of giving special rewards is not limited to the above example. For example, many game mediums may be paid out from the payout portion 213 to the player as special rewards. The first lottery event is an example of a “second lottery.”

The first lottery device 30 in FIG. 1 is used for the first lottery event. The second lottery devices 40 are each used for the second lottery event. Each of the first lottery event and the second lottery event is a physical lottery using a game object Qb. The game object Qb is a three-dimensional object that is rollable. In the first embodiment, a spherical object is an example of the game object Qb. However, the game object Qb may be in a shape such as a polyhedron or a disk. The game object Qb according to the first embodiment is made of magnetic material (particularly ferromagnetic material) such as iron, for example. Accordingly, the game object Qb is attracted by a magnet, such as a permanent magnet or an electromagnet, for example.

### B: First Lottery Device 30

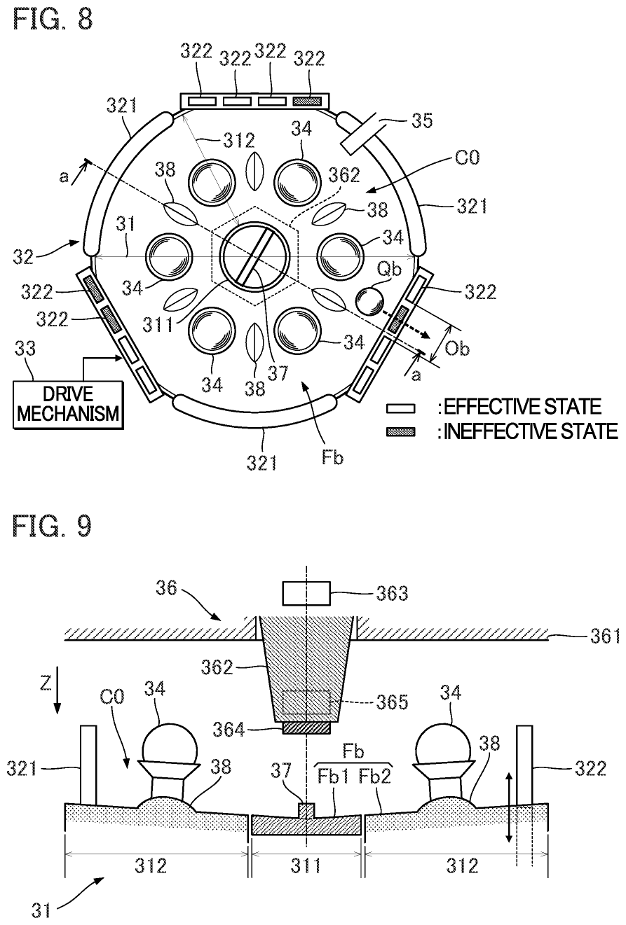

FIG. 8 is a plan view illustrating a configuration of the first lottery device 30, and FIG. 9 is a cross-sectional view taken along line a-a in FIG. 8. As illustrated in FIGS. 8 and 9, the first lottery device 30 is a physical lottery mechanism including a game mechanism 31, a drive mechanism 33, a plurality of urging bodies 34, a feeding mechanism 35, and a detecting mechanism 36.

The game mechanism 31 is a flat structure including a game surface Fb on which the game object Qb rolls. The game mechanism 31 according to the first embodiment includes a rotating body 311, a base 312, and a circumferential wall portion 32. The rotating body 311 is a circular plate-like member. The rotating body 311 includes a surface Fb1 that is a slope descending slightly from an outer peripheral edge of the rotating body 311 to a center of the rotating body 311. On the surface Fb1, a protrusion 37 is arranged. The protrusion 37 protrudes from the surface Fb1 of the rotating body 311. The protrusion 37 is a linear portion passing through the center of the rotating body 311 in plan view when viewed from the Z direction. The protrusion 37 and the rotating body 311 are formed integrally. However, the protrusion 37 formed separately from the rotating body 311 may be fixed to the surface Fb1.

The base 312 is a loop-shaped structure surrounding the rotating body 311 in plan view. In other words, the rotating body 311 is arranged within a circular opening of the base 312. The base 312 includes a surface Fb2 that is a slope descending from an outer peripheral edge of the base 312 to the inner peripheral edge of the base 312. On the surface Fb2 of the base 312, a plurality of protrusions 38 are arranged. The protrusions 38 each protrude from the surface Fb2. The protrusions 38 are arranged spaced from each other in the X direction (a circumferential direction). Each protrusion 38 and the base 312 are formed integrally. However, the protrusions 38 formed separately from the base 312 may be fixed to the surface Fb2. An inner diameter of the base 312 is slightly greater than an outer diameter of the rotating body 311. An inner peripheral surface of the base 312 and an outer peripheral surface of the rotating body 311 are adjacent to each other with a gap sufficiently smaller than an outer diameter of the game object Qb. With the above configuration as illustrated in FIG. 9, the surface Fb1 of the rotating body 311 and the surface Fb2 of the base 312 constitute the game surface Fb on which the game object Qb rolls. The protrusion 37 and the protrusions 38 are formed on the game surface Fb.

The circumferential wall portion 32 is a peripheral wall protruding from the game surface Fb along a peripheral edge of the game surface Fb. Specifically, the circumferential wall portion 32 is arranged in a loop shape along the outer periphery of the base 312. The circumferential wall portion 32 blocks the game object Qb from moving out of the surface of the game surface Fb. The circumferential wall portion 32 according to the first embodiment includes a plurality of fixed walls 321 and a plurality of movable walls 322, as illustrated in FIG. 8. The fixed walls 321 are circumferential walls fixedly arranged along the peripheral edge of the game surface Fb. The fixed walls 321 are arranged spaced apart from each other in the X direction (the circumferential direction). The movable walls 322 are arranged in the X direction. Each movable wall 322 is arranged between the fixed walls 321 that are next to each other. Each movable wall 322 is a movable structure. Specifically, a state of each movable wall 322 is changed from an effective state, in which the movable wall 322 protrudes from the game surface Fb, to an ineffective state in which the movable wall 322 is housed inside the game mechanism 31, and changed from the ineffective state to the effective state, as illustrated by arrows in FIG. 9. The effective state is a state in which the movable wall 322 functions effectively as a wall portion blocking the game object Qb from moving out of the game surface Fb. On the other hand, the ineffective state is a state in which the top of the movable wall 322 is below the game surface Fb. In other words, the ineffective state is a state in which the movable wall 322 does not function as the wall portion blocking the game object Qb from moving out of the game surface Fb. As illustrated in FIG. 8, when the state of the movable wall 322 changes to the ineffective state, an opening Ob is formed. The game object Qb is enterable to the opening Ob. In other words, the game object Qb passes through the opening above the movable wall 322 in the ineffective state, thus released outside the game mechanism 31. As will be understood from the above description, the first lottery event is carried out in a space C0 defined by both the game surface Fb of the game mechanism 31 and the circumferential wall portion 32. The top of the movable wall 322 may slightly protrude from the game surface Fb in the ineffective state.

The drive mechanism 33 drives the game mechanism 31 and each movable wall 322 under control by the controller 11. Specifically, the drive mechanism 33 rotates the rotating body 311 of the game mechanism 31. In addition, the drive mechanism 33 moves each movable wall 322 up and down to change the state of each movable wall 322 from one of the effective state and the ineffective state to the other. For example, the drive mechanism 33 is a motor or the like.

The urging bodies 34 are arranged spaced apart from each other. Specifically, the urging bodies 34 are arranged around the rotating body 311 along the X direction. Each urging body 34 is a structure to urge the game object Qb on the game surface Fb along the game surface Fb. Specifically, each urging body 34 repels the game object Qb, which runs into the urging body 34, in a direction opposite to a direction in which the game object Qb runs into the urging body 34.

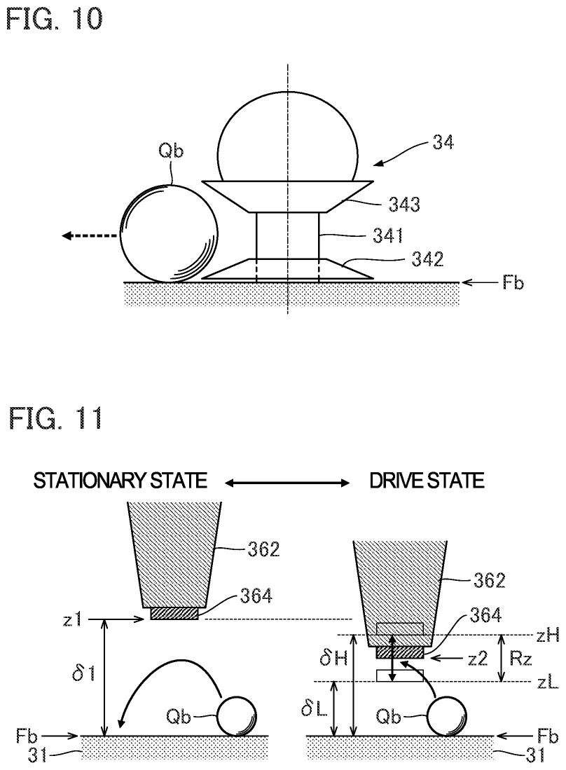

FIG. 10 is a side view illustrating the urging body 34. As illustrated in FIG. 10, the urging body 34 according to the first embodiment is a striking mechanism (bumper) that strikes the game object Qb along the game surface Fb. The urging body 34 includes a main body 341, a detector 342, and a striker 343. The main body 341 is a cylindrical structure protruding from the game surface Fb. The main body 341 includes a first portion and a second portion. The first portion of the main body 341 is adjacent to the game surface Fb. The second portion of the main body 341 is opposite to the first portion of the main body 341. The detector 342 is arranged on the first portion of the main body 341. The striker 343 is arranged on the second portion of the main body 341.

The detector 342 is a plate-like member in a loop shape surrounding the main body 341. The detector 342 includes a slope descending from an inner peripheral edge of the detector 342 to an outer peripheral edge of the detector 342. The striker 343 is a loop-shaped member surrounding the main body 341. The striker 343 includes a slope descending from an outer peripheral edge of the striker 343 to an inner peripheral edge of the striker 343. The main body 341 includes a mechanism that causes the striker 343 to instantaneously descend in response to a load acting on the detector 342. In the above configuration, when the game object Qb approaching the urging body 34 reaches an upper surface of the detector 342, the striker 343 instantaneously descends. Therefore, the game object Qb is struck by the slope of the striker 343, and is thus urged in a radial direction of the urging body 34. The urging body 34 is capable of urging the game object Qb that reaches from any direction corresponding to the circumference of the urging body 34.

The feeding mechanism 35 in FIG. 8 feeds the game object Qb onto the game surface Fb. The game object Qb fed by the feeding mechanism 35 rolls along the game surface Fb. Specifically, the game object Qb moves irregularly on the game surface Fb due to urging forces from each of the urging bodies 34, collisions against the protrusion 37 or against each of the protrusions 38, and collisions against the circumferential wall portion 32, while approaching the rotating body 311 by its own weight along the surface Fb2 of the base 312. In addition to moving along the game surface Fb in contact with the game surface Fb, the game object Qb leaps upward from the game surface Fb by colliding with the projection 37 or with the respective projections 38 while moving on the game surface Fb. In other words, the game object Qb moves away from the game surface Fb.

The detecting mechanism 36 is a mechanism that detects the game object Qb away from the game surface Fb. As illustrated in FIG. 9, the detecting mechanism 36 includes a support 361, a moving member 362, a drive mechanism 363, an opposing member 364, and a detector 365. The support 361 is a structure facing the game surface Fb with a space between the support 361 and the game surface Fb. In other words, the support 361 constitutes a ceiling of the game apparatus 1. The support 361 includes an opening facing a part of the game surface Fb. The moving member 362 is a pillar-shaped or pyramid-shaped structure protruding from the opening of the support 361 toward the game surface Fb. The moving member 362 is formed concentrically with the rotating body 311. In other words, a center axis of the moving member 362 coincides with a rotation axis of the rotating body 311.

The opposing member 364 is a member positioned above the game surface Fb. Specifically, the opposing member 364 is arranged at a lower end of the moving member 362 and faces the game surface Fb with a space between the opposing member 364 and the game surface Fb. The opposing member 364 according to the first embodiment is composed of a magnet such as a permanent magnet or an electromagnet. Therefore, the game object Qb made of magnetic material can attach to the opposing member 364.

The drive mechanism 363 moves the moving member 362 along an axis parallel to the Z direction under control by the controller 11. For example, the drive mechanism 363 includes a motor or the like. FIG. 11 is a diagram for describing movement of the moving body 362. As illustrated in FIG. 11, the drive mechanism 363 changes a state of the moving member 362 from one of a stationary state and a drive state to the other.

The stationary state is a state in which the moving member 362 is stationary. In the stationary state, a lower end surface of the opposing member 364 is positioned at a point z1 in the Z direction. Specifically, the lower end surface of the opposing member 364 faces the game surface Fb with a space δ1 greater than the outer diameter of the game object Qb.

On the other hand, the drive state is a state in which the moving member 362 moves. Specifically, the drive mechanism 363 causes the moving member 362 to reciprocate along the axis parallel to the Z direction. Therefore, in the drive state, the opposing member 364 moves in a direction away from the game surface Fb (that is, in a direction opposite to the Z direction) and then moves in a direction approaching the game surface Fb (that is, in the Z direction). That is, in the drive state, the opposing member 364 repeatedly reciprocates along the axis parallel to the Z direction. Specifically, the opposing member 364 reciprocates along the axis parallel to the Z direction within a range Rz centered at a point z2 in the Z direction. The range Rz is a range that is closer to the game surface Fb than the point z1 in the stationary state is (in other words, the range Rz is a range lower than the point z1 in the vertical direction). Thus, in the drive state, the drive mechanism 363 brings the opposing member 364 that is closer to the game surface Fb than the opposing member 364 in the stationary state is.

In a state in which the opposing member 364 is positioned at a point zH of an upper end of the range Rz, the opposing member 364 faces the game surface Fb with a space δH greater than the outer diameter of the game object Qb. In a state in which the opposing member 364 is positioned at a point zL of a lower end of the range Rz, the opposing member 364 faces the game surface Fb with a space SL greater than the outer diameter of the game object Qb.

As described above, the game object Qb rolling on the game surface Fb may leap upward from the game surface Fb. In the stationary state, the space δ1 between the opposing member 364 and the game object Qb is sufficiently large. Therefore, the game object Qb does not contact the opposing member 364 even when the game object Qb moves away from the game surface Fb in the vertical direction. In the drive state, when the opposing member 364 approaches the game surface Fb, the space between the opposing member 364 and the game object Qb is smaller than the space in the stationary state. Therefore, the game object Qb, which moves away from the game surface Fb vertically, may contact the opposing member 364. The game object Qb, which contacts the opposing member 364, attaches to the opposing member 364 by magnetic force. The probability that the game object Qb will attach to the opposing member 364 varies moment by moment in accordance with the position of the opposing member 364 in the Z direction. Specifically, the closer the opposing member 364 is to the point zL of the lower end of the range Rz, the greater the probability is that the game object Qb will contact the opposing member 364. As will be understood from the above description, the game object Qb can attach to the opposing member 364 in a limited situation in which the game object Qb leaps from the game surface Fb within a period of time in which the opposing member 364 is close to the point zL.

The detector 365 in FIG. 9 detects the contact of the game object Qb with the opposing member 364. The detector 365 according to the first embodiment detects attachment of the game object Qb to the opposing member 364. In a state in which the game object Qb is attached to the opposing member 364, a load of the game object Qb acts on the opposing member 364. Therefore, a load sensor (for example, a strain gauge) that detects the load acting on the opposing member 364 may be used as the detector 365. An optical sensor that optically detects presence or absence of the game object Qb, or a magnetic sensor that detects variation of a magnetic field due to the attachment of the game object Qb, may be used as the detector 365. As described above, the first lottery event is a game event to attach a single game object Qb to the opposing member 364 while the single game object Qb is rolling on the game surface Fb. The game event shifts from the first lottery event to the second lottery event in response to the attachment of the game object Qb to the opposing member 364.

As illustrated in FIG. 5, the controller 11 realizes a first controller 73 regarding the first lottery event by executing the program P1 stored in the storage device 12. The first controller 73 controls each element of the first lottery device 30. For example, the first controller 73 gives a benefit to the player in response to the detector 365 detecting the attachment of the game object Qb to the opposing member 364. As described above, in response to the game object Qb attaching to the opposing member 364, the game event is changed from the first lottery event to the second lottery event. In other words, the first controller 73 gives a right to play the second lottery event to the player as a benefit.

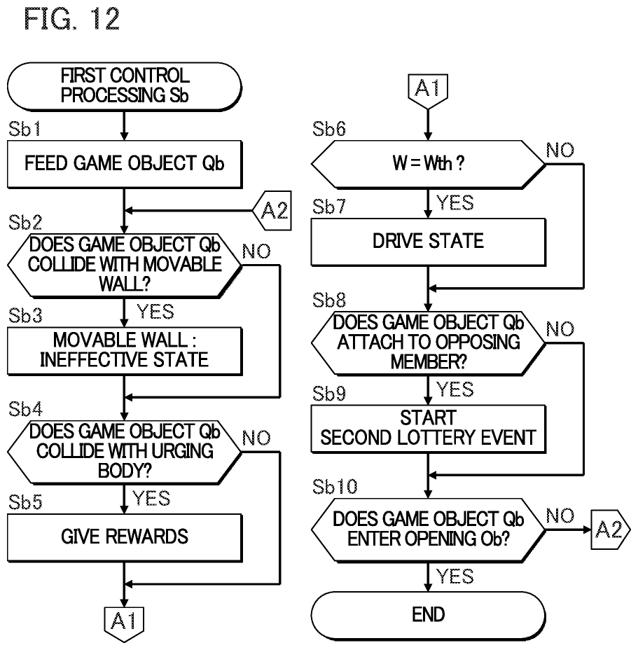

FIG. 12 is a flowchart illustrating a specific procedure of a processing (hereinafter referred to as a “first control processing”) Sb executed by the controller 11 with respect to the first lottery event. The first control processing Sb is started when the number N of the game objects Qa2 that have fallen into the opening Oa1 of the amusement device 20 reaches the predetermined value Nth.

In response to a start of the first control processing Sb, the first controller 73 controls the feeding mechanism 35 to feed a single game object Qb onto the game surface Fb (Sb1). The game object Qb fed onto the game surface Fb moves irregularly on the game surface Fb. The first controller 73 determines whether the game object Qb collides with the movable wall 322 (Sb2). When the game object Qb collides with the movable wall 322 (Sb2: YES), the first controller 73 accommodates the movable wall 322 in the game mechanism 31 to set the movable wall 322 to the ineffective state (Sb3). The game object Qb is enterable to the opening Ob formed by the transition of the movable wall 322 to the ineffective state.

The first controller 73 determines whether the game object Qb collides with one of the urging bodies 34 (Sb4). When the game object Qb collides with the urging body 34 (Sb4: YES), the first controller 73 gives rewards to the player (Sb5). For example, the first controller 73 feeds a predetermined number of game object Qa1 onto the placing surface Fa2 from the feeder 251. The payout portion 213 may pay out a predetermined quantity of game mediums as the rewards. As illustrated above, a predetermined quantity of rewards is given to the player each time the game object Qb collides with the urging body 34. When the game object Qb does not collide with any of the urging bodies 34 (Sb4: NO), no reward is given to the player.

The first controller 73 determines whether a cumulative value W of rewards given to the player in response to the collision of the game object Qb with the urging body 34 (hereinafter referred to as a “cumulative reward quantity”) reaches a predetermined threshold Wth (Sb6). When the cumulative reward quantity W reaches the threshold Wth (Sb6: YES), the first controller 73 controls the drive mechanism 363 to change the state of the moving member 362 from the stationary state to the drive state (Sb7). In the drive state, the opposing member 364 reciprocates along the axis parallel to the Z-direction within the range Rz centered at the point z2 lower than the point z1 in the stationary state, as illustrated in FIG. 11. As will be understood from the above description, the opposing member 364 approaches the game surface Fb when a predetermined condition, in which the cumulative reward quantity W reaches the threshold Wth, is satisfied. Therefore, the probability of the game object Qb contacting the opposing member 364, can be controlled in accordance with whether the predetermined condition is satisfied. On the other hand, when the cumulative reward quantity W does not reach the threshold Wth (Sb6: NO), the moving member 362 is maintained in the stationary state.

The first controller 73 determines whether the detector 365 detects the attachment of the game object Qb to the opposing member 364 (Sb8). When the game object Qb attaches to the opposing member 364 (Sb8: YES), the first controller 73 instructs the second lottery device 40 to start the second lottery event (Sb9). In other words, the right to carry out the second lottery event is given to the player as a benefit. On the other hand, when the attachment of the game object Qb to the opposing member 364 is not detected (Sb8: NO), the second lottery event is not started. As will be understood from the above description, the first controller 73 according to the first embodiment functions as an element (a benefit giver) that gives a benefit to the player when the detector 365 detects the attachment of the game object Qb to the opposing member 364. The first lottery event ends with the start of the second lottery event.

The first controller 73 determines whether the game object Qb enters the opening Ob of the circumferential wall portion 32 (Sb10). When the game object Qb enters the opening Ob (Sb10: YES), the first controller 73 ends the first lottery event. When the first lottery event ends, the player restarts the usual game by using the amusement device 20. On the other hand, when the game object Qb does not enter the opening Ob (Sb10: NO), the first controller 73 shifts processing to step Sb2 and executes each processing (Sb2 to Sb10) illustrated above. When the first lottery event ends (Sb8: YES, Sb10: YES), the first controller 73 controls the drive mechanism 363 to set the moving member 362 to the stationary state.

In the first lottery event, a plurality of game objects Qb may be fed onto the game surface Fb from the feeding mechanism 35 (Sb1). In a configuration in which the game objects Qb are fed, the first lottery event may end when one of the game objects Qb enters the opening Ob, or when all of the game objects Qb enter the opening Ob.

As described above, in the first embodiment, the benefit is given to a player when the game object Qb moves along the game surface Fb and then moves away from the game surface Fb to come into contact with the opposing member 364. Therefore, there is an advantage in that various movements of game object Qb, including movements of the game object Qb upwardly and away from the game surface Fb, in addition to movements of the game object Qb along the game surface Fb, can be used for the first lottery event. Also, since the game object Qb attaches to the opposing member 364, there is an advantage in that the player can visually confirm that a game object Qb that is away from the game surface Fb, contacts the opposing member 364.

According to the first embodiment, the game object Qb can move away from the game surface Fb by a simple configuration in which the game object Qb, which is urged by the urging body 34, collides with the projection 37 or with one of the projections 38. Furthermore, since the surface Fb2 of the base 312 is a slope descending toward the rotating body 311, the game object Qb moves on the surface Fb2 of the base 312 toward the rotating body 311. Therefore, the player can be given an expectation that the game object Qb will contact the opposing member 364.

In the first embodiment, the protrusions 38 are fixed to the game surface Fb. The protrusion 37 is arranged on the rotating body 311, thus rotating. Consequently, the strength with which the protrusion 37 strikes the game object Qb is greater than the strength with which the protrusions 38 strikes the game object Qb. In other words, a probability of the game object Qb attaching to the opposing member 364 due to a collision with the projection 37, is greater than a probability that the game object Qb will attach to the opposing member 364 due to a collision with the projection 38. Therefore, it is possible to cause the player to recognize a region in the vicinity of the rotating body 311 in the game surface Fb (that is, a central portion of the game surface Fb) as a chance zone having a high probability of the game object Qb attaching to the opposing member 364.

In the first embodiment, the game object Qb moving toward the peripheral edge of the game surface Fb collides with the circumferential wall portion 32. Therefore, the circumferential wall portion 32 prevents the game object Qb from moving out of the game surface Fb. Consequently, it is possible to easily maintain a state, in which the game object Qb moves on the game surface Fb, for a long time. Furthermore, the game object Qb may enter the opening Ob without contacting the opposing member 364. Therefore, there is an advantage in that a variety of games can be realized compared with a configuration in which the opening Ob is not formed.

As the opposing member 364 approaches the game surface Fb, a probability of the game object Qb contacting the opposing member 364 increases. As the opposing member 364 moves away from the game surface Fb, the probability of the game object Qb contacting the opposing member 364 decreases. In other words, by a simple configuration in which the opposing member 364 reciprocates, it is possible to change the probability of the game object Qb contacting the opposing member 364 over time.

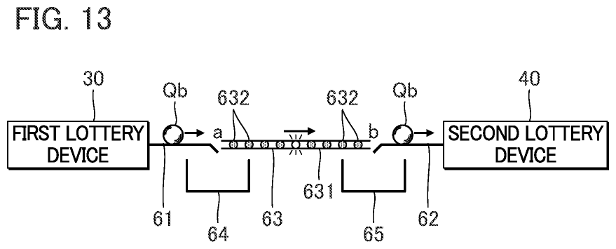

After the game object Qb attaches to the opposing member 364 in the first lottery event, the game object Qb is transported from the first lottery device 30 to the second lottery device 40 and then is used for the second lottery event. FIG. 13 is a diagram illustrating a configuration causing the game object Qb to move from the first lottery device 30 to the second lottery device 40.

A first travel path 61, a fake path 63, and a second travel path 62 are arranged between the first lottery device 30 and the second lottery device 40. Each of the first travel path 61 and the second travel path 62 is a path on which the game object Qb moves. For example, rails including two parallel bars with an interval less than the outer diameter of the game object Qb are used as each of the first travel path 61 and the second travel path 62.

The first travel path 61 is a path for moving the game objects Qb from the first lottery device 30 to a first storage container 64. The second travel path 62 is a path for moving a game object Qb from a second storage container 65 to the second lottery device 40. Each of the first storage container 64 and the second storage container 65 is a container for storing game objects Qb.

The fake path 63 is arranged between the first travel path 61 and the second travel path 62 to virtually express movement of the game object Qb. Specifically, the fake path 63 has a path member 631 and a plurality of light emitters 632. The path member 631 includes an end “a” facing the first travel path 61 and an end “b” facing the second travel path 62. The path member 631 extends from the end “a” to the end “b.” The plurality of light emitters 632 are arranged along the path member 631. The game object Qb is virtually represented by one of the light emitters 632 that temporarily emits light. In other words, the movement of the game object Qb is virtually represented by switching a light emitter to be emitted among the light emitters 632 from a light emitter 632 adjacent to the end “a” to a light emitter 632 adjacent to the end “b” in the order of arrangement over time.

Specifically, the controller 11 causes the light emitter 632 adjacent to the end “a” among the light emitters 632 to emit light at a point in time when the game object Qb supplied from the opposing member 364 reaches the first storage container 64 through the first travel path 61. The controller 11 switches a light emitter 632, which emits light, in the order of the arrangement over time. Then, the controller 11 supplies a game object Qb stored in the second storage container 65 to the second travel path 62 at a point in time when the light emitter 632 adjacent to the end “b” among the light emitters 632 emits light. The game object Qb passes through the second travel path 62 and is supplied to the second lottery device 40. As will be understood from the above description, a part of the path from the first lottery device 30 to the second lottery device 40 includes the fake path 63. Therefore, it is possible to cause the player to perceive that a game object Qb moves from the first lottery device 30 to the second lottery device 40 even if a continuous path from the first lottery device 30 to the second lottery device 40 is absent. A part or all of the fake path 63 may be replaced by the display 22 that displays an image (an image representative of the movement of the game object Qb).

### C: Second Lottery Device 40

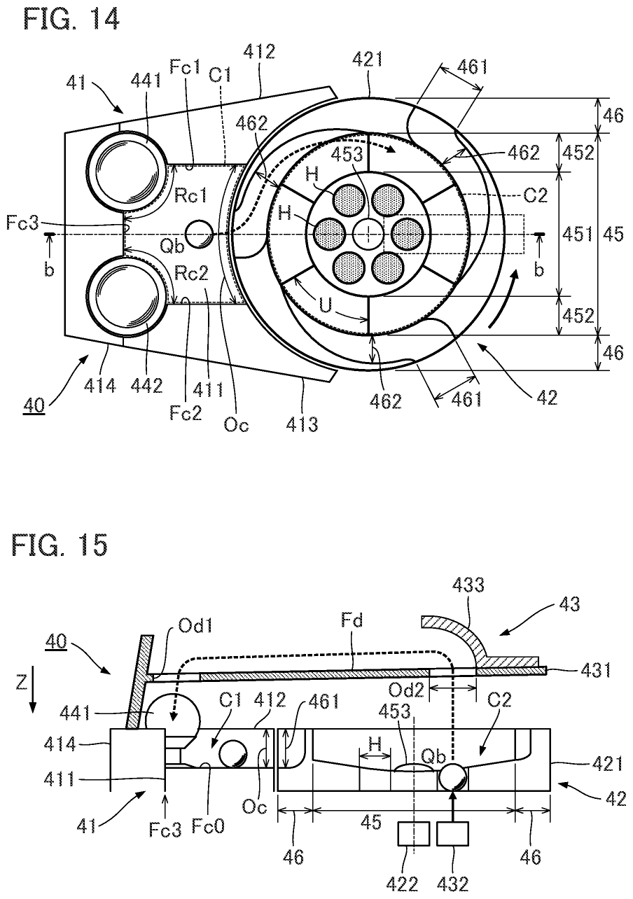

FIG. 14 is a plan view illustrating a configuration of the second lottery device 40, and FIG. 15 is a cross-sectional view taken along line b-b in FIG. 14. As illustrated in FIGS. 14 and 15, the second lottery device 40 includes a first structure 41, a second structure 42, and a transport structure 43. In FIG. 14, an illustration of the transport structure 43 is omitted for convenience.

The first structure 41 forms a first space C1 in which the game object Qb is supplied. Specifically, the first structure 41 includes a bottom portion 411, a first side wall portion 412, a second side wall portion 413, a rear wall portion 414, a first urging body 441, and a second urging body 442. In the following descriptions, when there is no need to distinguish between the first and second urging bodies 441 and 442, each of the first and second urging bodies 441 and 442 will simply be referred to as an “urging body 44.”

The bottom portion 411 is a plate-like member that constitutes a bottom surface of the first space C1. As illustrated in FIG. 15, the first side wall portion 412, the second side wall portion 413, and the rear wall portion 414 protrude vertically upwardly from a surface Fc0 of the bottom portion 411. The height of each of an inner wall surface Fc1 of the first side wall portion 412, an inner wall surface Fc2 of the second side wall portion 413, and an inner wall surface Fc3 of the rear wall portion 414 is greater than half of the outer diameter of the body Qb.

As illustrated in FIG. 14, the first side wall portion 412 and the second side wall portion 413 face each other across the surface Fc0 of the bottom portion 411. The rear wall portion 414 is arranged on a position opposite to the second structure 42 when viewed from the surface Fc0 of the bottom portion 411. The first space C1 is a space defined by the inner wall surface Fc1 of the first side wall portion 412, the inner wall surface Fc2 of the second side wall portion 413, and the inner wall surface Fc3 of the rear wall portion 414. The first space C1 includes an opening Oc facing the inner wall surface Fc3 of the rear wall portion 414. The opening Oc communicates with the second structure 42.

The first urging body 441 and the second urging body 442 are arranged spaced apart from each other in the first space C1. Specifically, the first urging body 441 is arranged between the inner wall surface Fc1 of the first side wall portion 412 and the inner wall surface Fc3 of the rear wall portion 414. Similarly, the second urging body 442 is arranged between the inner wall surface Fc2 of the second side wall portion 413 and the inner wall surface Fc3 of the rear wall portion 414. Each urging body 44 has the same configuration as that of the urging body 34 illustrated in FIG. 10. When the game object Qb collides with the urging body 44, the urging body 44 urges (that is, repels) the game object Qb in a direction opposite to a direction in which the game object Qb runs into the urging body 44. Each time the game object Qb collides with the urging bodies 44, rewards of which quantity is K are given to the player. For example, each time the game object Qb collides with the urging body 44, K game objects Qa1 are fed onto the placing surface Fa2 of the amusement device 20.

FIG. 14 is a plan view illustrating a range Rc1 centered at the first urging body 441 and a range Rc2 centered at the second urging body 442. The range Rc1 is a range between the inner wall surface Fc1 of the first side wall portion 412 and the inner wall surface Fc3 of the rear wall portion 414. In other words, the range Rc1 is a range composed of a portion of an area around the first urging body 441. The first urging body 441 urges the game object Qb, which moves from a point in the range Rc1 toward the first urging body 441 and then collides with the first urging body 441, toward the point in the range Rc1. In other words, the game object Qb that collides with the first urging body 441 is urged toward the range Rc1. At least a part of the second urging body 442 is arranged in the range Rc1.

Similarly, the range Rc2 is a range between the inner wall surface Fc2 of the second side wall portion 413 and the inner wall surface Fc3 of the rear wall portion 414. In other words, the range Rc2 is a range composed of a portion of an area around the second urging body 442. The second urging body 442 urges the game object Qb, which moves from a point in the range Rc2 toward the second urging body 442 and then collides with the second urging body 442, toward the point in the range Rc2. In other words, the game object Qb that collides with the second urging body 442 is urged toward the range Rc2. At least a part of the first urging body 441 is arranged in the range Rc2. Each of the ranges Rc1 and Rc2 is set at an angle of 120 degrees or less (for example, 90 degrees or less), for example.

The game object Qb is supplied to the first space C1 from the second travel path 62 in FIG. 13. The game object Qb supplied to the first space C1 rolls while repeatedly colliding with each urging body 44 and/or each inner wall surface (Fc1, Fc2, Fc3) defining the first space C1. As described above, in the first embodiment, the first urging body 441 urges the game object Qb toward the range Rc1 including the second urging body 442, and the second urging body 442 urges the game object Qb toward the range Rc2 including the first urging body 441. Therefore, a state is easily maintained in which the game object Qb reciprocates at high speed between the first and second urging bodies 441 and 442.

As illustrated in FIGS. 14 and 15, the second structure 42 forms a second space C2. Specifically, the second structure 42 includes a lottery board 421 and a drive mechanism 422. The lottery board 421 is a circular structure (a so-called a “distributor”) including a lottery member 45 and a circumferential wall portion 46. The lottery member 45 and the circumferential wall portion 46 are formed unitarily. However, the circumferential wall portion 46, which is formed separately from the lottery member 45, may be fixed to the lottery member 45. In the following descriptions, a direction along a circumference of a virtual circle centered at a central axis of the lottery board 421 is referred to as a “circumferential direction” and a direction of a radius of the virtual circle is referred to as a “radial direction.”

The lottery member 45 is a rotatable disk-shaped structure. As illustrated in FIG. 14, the lottery member 45 according to the first embodiment includes a lottery portion 451 and a display 452. The lottery portion 451 is a circular-shaped portion in plan view. The lottery portion 451A includes a surface that has a slope slightly descending from an outer periphery edge of the lottery portion 451 to a center of the lottery portion 451. The lottery portion 451 includes a plurality of lottery holes H (for example, five lottery holes H) and a protrusion 453. Each lottery hole H is a circular opening into which the game object Qb is capable of entering. The lottery holes H are arranged spaced from each other along the circumferential direction. The game object Qb, which enters the lottery hole H, is kept in the lottery hole H. The protrusion 453 has a circular shape. The protrusion 453 is arranged at a center of the lottery portion 451. The protrusion 453 protrudes from the surface of the lottery portion 451. Therefore, the game object Qb on the surface of the lottery portion 451 is guided into the lottery hole H.

The display 452 is a loop-shaped portion surrounding the lottery portion 451. The display 452 includes a surface that is a slope descending from an outer peripheral edge of the display 452 to an inner peripheral edge of the display 452. The display 452 displays an image in accordance with an instruction from the controller 11. The display 452 according to the first embodiment is partitioned into a plurality of portions (hereinafter referred to as “unit display portions”) U corresponding to the lottery holes H respectively. The unit display portions U are arranged along the circumferential direction. The display 452 is capable of displaying an image on each of the unit display portions U.

The circumferential wall portion 46 is a loop-shaped structure surrounding the lottery member 45. The circumferential wall portion 46 protrudes from a surface of the lottery member 45. The height of the top of the circumferential wall portion 46 is approximately equal to the height of each of the first side wall portion 412 and the second side wall portion 413 in the first structure 41. The second space C2 is a space that has a bottom surface defined by the lottery member 45. The second space C2 is surrounded by the circumferential wall portion 46.

The circumferential wall portion 46 includes a plurality of communication ports 461. Specifically, the communication ports 461 (for example, 3 communication ports 461) are formed on an outer peripheral surface of the circumferential wall portion 46 spaced from each other along the circumferential direction. Each communication port 461 is an opening communicating between the first space C1 and the second space C2. Each communication port 461 is formed in a size such that the game object Qb is capable of passing through the communication port 461. The circumferential wall portion 46 includes introduction passages 462 corresponding to the communication ports 461 respectively. Each introduction passage 462 is a spiral passage extending from the corresponding communication port 461 to the surface of the lottery member 45 in the circumferential direction.

In the above configuration, the game object Qb, which passes through the communication port 461 from the first space C1, moves to the surface of the lottery member 45 by rolling under its own weight on the surface of the introduction passage 462. In other words, each communication port 461 and each introduction passage 462 are passages for moving the game object Qb from the first space C1 to the second space C2. The game object Qb is accelerated in the introduction passage 462 and then supplied to the second space C2. The acceleration of the game object Qb by the introduction passage 462 reduces the probability of most of the game objects Qb entering a particular lottery hole H. In other words, the introduction passages 462 contribute to the game objects Qb randomly entering into many lottery holes H. The game object Qb, which is supplied to the second space C2 through the communication port 461 and the introduction passage 462, gradually approaches the lottery member 45 by its own weight while rolling circumferentially on the surface of the display 452, and finally enters one of the lottery holes H.

The drive mechanism 422 is a driver that rotates the lottery board 421. Specifically, the lottery member 45 and the circumferential wall portion 46 rotate together with each other. For example, a motor or the like is used as the drive mechanism 422. The drive mechanism 422 rotates the lottery board 421 to change one of states, consisting of a communication state and a holding state, to the other. The communication state is a state in which one of the communication ports 461 is positioned in the opening Oc of the first space C1. The holding state is a state in which any of the communication ports 461 is not positioned in the opening Oc of the first space C1. In other words, the communication state is a state in which the first space C1 and the second space C2 are communicated with each other through the communication port 461. In the communication state, the game object Qb moves from the first space C1 through the communication port 461 and the introduction passage 462 to the second space C2. On the other hand, the holding state is a state in which the game object Qb is blocked from passing through the communication port 461. Specifically, in the holding state, the game object Qb remains in the first space C1 while colliding with the outer peripheral surface of the circumferential wall portion 46.

The transport structure 43 in FIG. 15 is a structure for transporting the game object Qb from the second space C2 to the first space C1. The transport structure 43 according to the first embodiment includes a transport plate 431, an ejection mechanism 432, and a collision portion 433. The transport plate 431 is a plate-like member covering the first space C1 and the second space C2. The transport plate 431 is formed of a transparent material. Therefore, the player can see a state of the game object Qb in the first space C1 or in the second space C2 via the transport plate 431.

The transport plate 431 includes an opening Od1 and an opening Od2. Each of the openings Od1 and Od2 is a substantially circular through-hole through which the game object Qb is capable of passing. The opening Od1 overlaps with the first space C1 in plan view. Specifically, the opening Od1 overlaps with a space between the first and second urging bodies 441 and 442 in plan view. The opening Od2 overlaps with the second space C2 in plan view. Specifically, the opening Od2 is formed at a position that overlaps with one of the lottery holes H in plan view.

The transport plate 431 includes a surface (hereinafter referred to as a “rolling surface”) Fd that is a slope descending from the opening Od2 to the opening Od1. Therefore, the game object Qb supplied to the rolling surface Fd of the transport plate 431 rolls by its own weight toward the opening Od1, and passes through the opening Od1, and finally falls into the first space C1. As will be understood from the above description, the rolling surface Fd of the transport plate 431 functions as a supply path to move the game object Qb from the second space C2 to the first space C1.

The ejection mechanism 432 is arranged at a position that is below the lottery board 421 and that overlaps with the opening Od2. The ejection mechanism 432 ejects the game object Qb, which is stored in the lottery hole H directly below the opening Od2, vertically upward. Specifically, the game object Qb in the lottery hole H is ejected from the lottery hole H by the ejection mechanism 432 when the game object Qb moves directly below the opening Od2 by rotation of the lottery board 421. The game object Qb, which is ejected vertically upward by the ejection mechanism 432, passes through the opening Od2.

The collision portion 433 is a structure overlapping with the opening Od2 in plan view. Specifically, the collision portion 433 includes a curved surface (for example, a circular arc surface) curving from a peripheral edge of the opening Od2 toward the opening Od1. The game object Qb is ejected by the ejection mechanism 432, and then passes through the opening Od2, and then collides with the curved surface of the collision portion 433. The collision with the collision portion 433 changes a direction of movement of the game object Qb from the vertical direction to the horizontal direction. Therefore, after colliding with the collision portion 433, the game object Qb is supplied to the rolling surface Fd of the transport plate 431. As will be understood from the above description, the game object Qb moves from the lottery hole H to the rolling surface Fd of the transport plate 431 by the ejection by the ejection mechanism 432, and then collides with the collision portion 433, and then rolls on the rolling surface Fd, and then is supplied to the first space C1 through the opening Od1.

Furthermore, when the speed of the ejection by the ejection mechanism 432 is sufficient, the game object Qb can roll to the opening Od1 even if the rolling surface Fd is not inclined, for example. In the configuration in which the game object Qb is guided to the opening Od1 as described above, the rolling surface Fd need not be a slope, and may be a horizontal plane. In the above description, the game object Qb is moved from the lottery hole H to the opening Od1 by the ejection mechanism 432. However, a configuration for moving the game object Qb from the lottery hole H to the first space C1 is not limited to the above examples. For example, after passing through the lottery hole H, the game object Qb may be collected at a position below the lottery board 421, and then the game object Qb may be moved to the first space C1 by a transport mechanism not overlapping with the lottery board 421. After passing through the lottery hole H, the game object Qb may be collected, and then a game object Qb different from the game object Qb that has passed through the lottery hole H may be supplied to the first space C1 by a conveying mechanism. According to the above configuration, the player may perceive that the game object Qb that has passed through the lottery hole H is supplied to the first space C1.

Each of the lottery holes H is assigned one of lottery elements L (La, Lb, Lc). An operation of entering the game object Qb into one of the lottery holes H corresponds to a physical lottery (hereinafter referred to as a “special lottery”) in which a lottery element L corresponding to the lottery hole H into which the game object Qb enters is selected from among the lottery elements L in accordance with probabilities. In other words, among the lottery elements L, one lottery element L which corresponds to the lottery hole H into which the game object Qb enters is a result of the special lottery. As will be understood from the above description, the second space C2 is a space for carrying out the special lottery using the game object Qb. In other words, the second lottery event includes a cycle including high-speed movement of the game object Qb in the first space C1, the special lottery in the second space C2, and movement of the game object Qb from the second space C2 to the first space C1. The special lottery is an example of a “first lottery” or a “lottery process.”

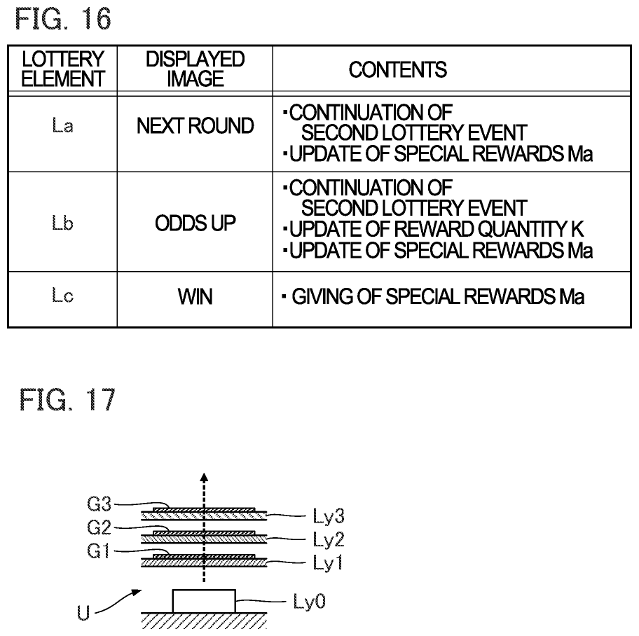

The unit display portion U corresponding to each lottery hole H displays an image representative of the lottery element L corresponding to the lottery hole H. FIG. 16 is a diagram illustrating an outline of each lottery element L. A unit display portion U, corresponds to the lottery hole H to which the lottery element La is assigned, displays an image G1 representative of “NEXT ROUND.” The lottery element La means continuation of the second lottery event and update of the quantity Ma of special rewards. A unit display portion U, which corresponds to the lottery hole H to which the lottery element Lb is assigned, displays an image G2 representative of “ODDS UP.” The lottery element Lb means the continuation of the second lottery event, update of the quantity K of rewards, and the update of the quantity Ma of special rewards. In other words, the quantity K of the rewards, which are given to the player each time the game object Qb collides with the urging body 44, is updated to a numerical value selected by an electronic lottery, for example. The quantity K may be increased by a predetermined value each time the lottery element Lb is selected.

A unit display portion U, which corresponds to the lottery hole H to which the lottery element Lc is assigned, displays an image G3 representative of “WIN.” The lottery element Lc means giving of the special rewards (JACKPOT) to the player. In other words, in the second lottery event, the game object Qb entering the lottery hole H corresponding to the lottery element Lc means that the player wins the special lottery. The quantity Ma of special rewards increases by a predetermined value each time the lottery element La or the lottery element Lb is selected in the special lottery. The lottery element L, which means that the player loses the special lottery, may be assigned to a lottery hole H, for example.

FIG. 17 is a cross-sectional view illustrating a configuration of the unit display portion U. As illustrated in FIG. 17, the unit display portion U includes a light-emitting element Ly0, a first layer Ly1, a second layer Ly2, and a third layer Ly3. The first layer Ly1, the second layer Ly2, and the third layer Ly3 are stacked one on another. Specifically, the third layer Ly3 is closer to the player (for example, over the second layer Ly2) than the second layer Ly2 is, and the first layer Ly1 is farther away the player than the second layer Ly2 is (for example, below the second layer Ly2).

The first layer Ly1 is a transparent substrate having a surface on which the image G1 is formed. The image G1 is formed with a color material through which a light component of a first color (for example, red) passes. The second layer Ly2 is a transparent substrate having a surface on which the image G2 is formed. The image G2 is formed with a color material through which a light component of a second color (for example, blue) passes. The third layer Ly3 is a semitransparent reflective substrate having a surface on which the image G3 is formed.

The light emitting element Ly0 is a light source capable of emitting light in one of colors including the first color and the second color. A part of the light emitted from the light emitting element Ly0 passes through the first layer Ly1, the second layer Ly2, and the third layer Ly3, and then reaches the player. When the light emitting element Ly0 is turned off, the player can see the image G3 formed on the outermost third layer Ly3. On the other hand, when the light emitting element Ly0 emits light in the first color, the player can see the image G2 formed on the second layer Ly2 in the second color. When the light emitting element Ly0 emits light in the second color, the player can see the image G1 formed on the first layer Ly1 in the first color. As will be understood from the above description, an image, which is displayed on the unit display portion U according to the first embodiment, varies in accordance with the color of the light emitted from the light-emitting element Ly0. The unit display portion U may be a display panel such as a liquid crystal display panel or an organic EL panel.

As illustrated in FIG. 5, the controller 11 executes the program P2 stored in the storage device 12 to realize a second controller 74 regarding the second lottery event. The second controller 74 controls each element of the second lottery device 40. The second controller 74 is an example of a “controller.”

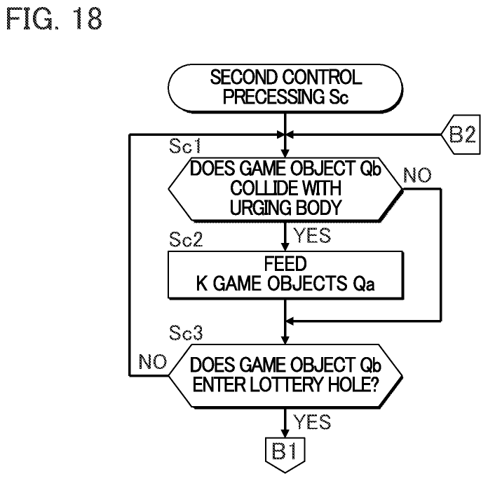

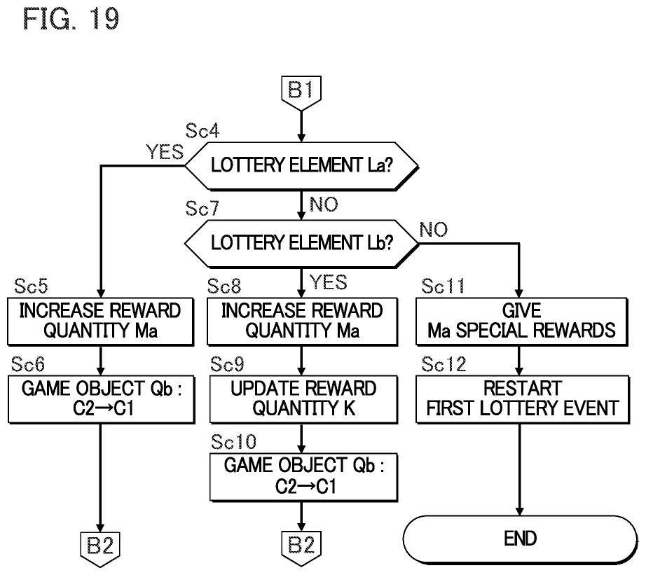

FIGS. 18 and 19 are each a flowchart illustrating a specific procedure of a processing (hereinafter referred to as a “second control processing”) Sc executed by the controller 11 with respect to the second lottery event. When the start of the second lottery event is instructed by the first controller 73 (Sb9), the second control processing Sc is started after the game object Qb is supplied to the first space C1.

As illustrated in FIG. 18, when the second control processing Sc is started, the second controller 74 determines whether the game object Qb collides with the urging body 44 (441, 442) (Sc1). When the game object Qb collides with the urging body 44 (Sc1: YES), the second controller 74 gives rewards to the player (Sc2). Specifically, the second controller 74 feeds K game objects Qa1 onto the placing surface Fa2 of the amusement device 20 from the feeder 251. On the other hand, when the game object Qb does not collide with the urging body 44 (Sc1: NO), no rewards are given to the player.

The game object Qb rolls at a high speed while repeatedly colliding with the inner wall surface (Fc1, Fc2, Fc3) and with the urging body 44 in the first space C1. Then, the game object Qb moves from the first space C1 to the second space C2 by entering the communication port 461 within a period of time in which the communication port 461 is located in the opening Oc of the first space C1. In other words, the special lottery is started in which one of the lottery elements L is selected in accordance with probabilities.

The second controller 74 determines whether the game object Qb enters one of the lottery holes H (Sc3). When the game object Qb does not enter any of the lottery holes H (Sc3: NO), the second controller 74 shifts the processing to step Sc1 to determine whether the game object Qb collides with the urging body 44. On the other hand, when the game object Qb enters one of the lottery holes H (Sc3: YES), the second controller 74 executes a processing (Sc4 to Sc12) in accordance with the lottery element L (hereinafter referred to as a “winning element”) corresponding to the lottery hole H into which the game object Qb enters, as illustrated in FIG. 19.

The second controller 74 determines whether the winning element is the lottery element La (Sc4). When the winning element is the lottery element La (NEXT ROUND) (Sc4: YES), the second controller 74 increases the quantity Ma of special rewards by a predetermined value (Sc5). Then, the second controller 74 moves the game object Qb in the lottery hole H from the second space C2 to the first space C1 by operating the ejection mechanism 432 (Sc6). The second controller 74 shifts the processing to step Sc1. In other words, the second lottery event is continued.

When the winning element is not the lottery element La (Sc4: NO), the second controller 74 determines whether the winning element is the lottery element Lb (Sc7). When the winning element is the lottery element Lb (ODDS UP) (Sc7: YES), the second controller 74 increases the quantity Ma of special rewards by a predetermined value (Sc8). In addition, the second controller 74 updates the quantity K of rewards. The rewards of which the quantity is K are given to the player when the game object Qb collides with the urging object 44 (Sc9). Then, the second controller 74 moves the game object Qb in the lottery hole H from the second space C2 to the first space C1 by operating the ejection mechanism 432 (Sc10). The second controller 74 shifts the processing to step Sc1. In other words, the second lottery event is continued. As will be understood from the above description, each time the lottery element La or the lottery element Lb is selected by the special lottery, the quantity Ma of special rewards is increased by the predetermined value. In other words, the greater the number of times the second lottery event is continued (the number of times the lottery element La or the lottery element Lb is selected), the larger the quantity Ma of special rewards is. As will be understood from the above description, the second controller 74 functions as an element (a reward quantity controller) that changes, in accordance with progress of the second lottery event, the quantity of special rewards (a first reward quantity) Ma to be given to the player who wins the special lottery.

When the winning element is not the lottery element Lb (Sc7: NO), the winning element is the lottery element Lc. When the winning element is the lottery element Lc (Sc7: NO), the second controller 74 gives the special rewards of which the quantity is Ma to the player (Sc1). For example, the second controller 74 feeds the Ma game objects Qa1 onto the placing surface Fa2 of the amusement device 20 from the feeder 251. In response to giving the special rewards to the player, the second controller 74 instructs the first lottery device 30 to restart the first lottery event (Sc12) and ends the second control processing Sc. When the second control processing Sc (the second lottery event) ends, the game object Qb is collected from the lottery hole H by a collection mechanism different from the ejection mechanism 432.

As will be understood from the above description, when the lottery element La or the lottery element Lb is selected by the special lottery, the second controller 74 moves the game object Qb from the second space C2 through the rolling surface Fd (the supply path) of the transport plate 431 to the first space C1 and increases the special rewards to be given to the player. In addition, the second controller 74 gives the special rewards to the player when the lottery element Lc is selected by the special lottery. In the first embodiment, the special rewards increases each time the lottery element La or the lottery element Lb is selected by the special lottery. Therefore, it is possible to provide the player with expectation of the special rewards increasing in accordance with movement of the game object Qb from the second space C2 to the first space C1. The lottery element La and the lottery element Lb are each an example of a “first lottery element.” The lottery element Lc is an example of a “second lottery element.”

The first controller 73 restarts the first control processing Sb in FIG. 12 in response to the instruction from the second controller 74. Therefore, the first lottery event, in which a lottery is used to determine whether to start the special lottery, is started in the space C0 in accordance with the result of the special lottery in the second lottery event. The first lottery event and the second lottery event are repeatedly carried out until the game object Qb enters the opening Ob in the first lottery event. As described above, according to the first embodiment, it is possible to realize various lotteries including the first lottery event and the second lottery event. The space C0 is an example of a “third space.”

As described above, in the first embodiment, the movement of the game object Qb from the first space C1 to the second space C2 is blocked in the holding state. Therefore, the game object Qb stays in the first space C1 while being repeatedly urged by the respective urging bodies 44. On the other hand, in the communication state, the game object Qb, which is urged by the first or second urging body 441 or 442, is movable from the first space C1 to the second space C2. Therefore, in the communication state, it is possible to carry out the special lottery with the game object Qb after the player sees an effective performance in which the game object Qb is repeatedly urged in the first space C1, compared with a configuration in which the game object Qb is supplied to the second space C2 without passing through the first space C1.

In the first embodiment, it is possible to change one of the states, between the communication state and the holding state, to the other by a simple configuration that switches a state of the configuration between a state in which the game object Qb is passable through the communication port 461 and a state in which a passing through the communication port 461 is blocked. Furthermore, since the circumferential wall portion 46 including the communication port 461 rotates, it is possible to reduce the probability that the game object Qb too easily moves from the first space C1 to the second space C2. In other words, it is possible to allow the game object Qb to appropriately stay in the first space C1.

In the first embodiment, the game object Qb moves from the first space C1 to the second space C2 in the communication state, and then moves from the second space C2 to the first space C1. In other words, the game object Qb circulates between the first space C1 and the second space C2. Therefore, it is possible to alternate between the holding of the game object Qb in the first space C1 and the special lottery using the game object Qb in the second space C2.

### D: Display of Image

As described above, the quantity of special rewards in the second lottery event (hereinafter referred to as a “provisional reward quantity”) Ma changes in accordance with the progress of the second lottery event. As described above, the provisional reward quantity Ma is the quantity of special rewards to be given to the player winning the special lottery. The provisional reward quantity Ma is stored in the storage device 12 and is updated in step Sc5 or step Sc8 of the second control processing Sc. In the first embodiment, an image representative of the provisional reward quantity Ma (hereinafter referred to as a “reward image”) is displayed on the display 22.

As illustrated in FIG. 5, the controller 11 executes the program P3 stored in the storage device 12 to realize a plurality of functions (a reward quantity acquirer 75 and a display controller 76) for displaying the reward image on the display 22. A function of the second controller 74 (a reward controller/Sc5, Sc8) for changing the provisional reward quantity Ma in accordance with the progress of the second lottery event may be realized by the controller 11 executing the program P3.

The reward quantity acquirer 75 acquires the quantity of rewards (hereinafter referred to as a “reference reward quantity”) Mb to be compared with the provisional reward quantity Ma. Specifically, the reward quantity acquirer 75 acquires the reference reward quantity Mb from the information manager 3 by communicating with the information manager 3 through the communicator 13. The provisional reward quantity Ma is an example of a “first reward quantity”, and the reference reward quantity Mb is an example of a “second reward quantity.”

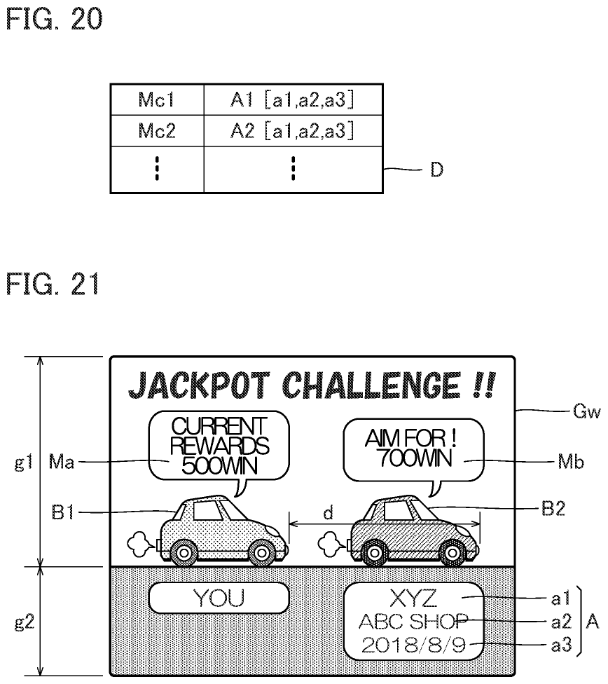

FIG. 20 is a diagram for describing information stored in the information manager 3. As illustrated in FIG. 20, the information manager 3 stores reward history data D. The reward history data D is a data table in which a plurality of reward quantities Mc (for example, Mc1 and Mc2) given to respective players in the second lottery event in the past, are registered. In other words, the reward history data D includes the reward quantity Mc for each past second lottery event in which special rewards were given to the respective players. The reward history data D according to the first embodiment includes, for each of the reward quantities Mc, attached data “A” (for example, A1 and A2) concerning acquisition of the special rewards of which the quantity is the reward quantity Mc. The attached data “A” corresponding to a reward quantity Mc among the reward quantities Mc includes, for example, an acquiring player “a1”, an acquisition facility “a2”, and an acquisition date and time “a3.” The acquiring player “a1” is a name of a player who acquired the special rewards of which the quantity is the reward quantity Mc. The acquisition facility “a2” is a name of an amusement facility in which the acquiring player acquired the special rewards of which the quantity is the reward quantity Mc. The acquisition date and time “a3” is a date and time at which the acquiring player acquired the special reward of which the quantity is the reward quantity Mc.

The reward quantity acquirer 75 acquires, as the reference reward quantity Mb, the reward quantity Mc corresponding to the current provisional reward quantity Ma among the reward quantities Mc registered in the reward history data D from the information manager 3. The reward quantity acquirer 75 according to the first embodiment acquires, as the reference reward quantity Mb, the reward quantity Mc greater than the provisional reward quantity Ma from among the reward quantities Mc. Specifically, the reward quantity Mc, which is greater than the provisional reward quantity Ma and which is closest to the provisional reward quantity Ma, is acquired from among the reward quantities Mc as the reference reward quantity Mb. In addition to the reference reward quantity Mb corresponding to the provisional reward quantity Ma, the reward quantity acquirer 75 according to the first embodiment acquires the attached data “A” corresponding to the reference reward quantity Mb from the information manager 3.

The display controller 76 causes the display 22 to display the reward image. The reward image according to the first embodiment is an image for comparing the provisional reward quantity Ma and the reference reward quantity Mb acquired by the reward quantity acquirer 75. In other words, the reward image is an image representative of both the provisional reward quantity Ma and the reference reward quantity Mb to be compared to each other.

FIG. 21 is a schematic diagram illustrating a reward image Gw. As illustrated in FIG. 21, the reward image Gw is an image including a first region g1 and a second region g2. The first region g1 represents a first object B1 and a second object B2. The first object B1 corresponds to the provisional reward quantity Ma. The second object B2 corresponds to the reference reward quantity Mb. The first object B1 is an image representative of the provisional reward quantity Ma. In other words, the first object B1 is an image representative of a current player who aims to acquire rewards of which the quantity is the provisional reward quantity Ma. On the other hand, the second object B2 is an image representative of the reference reward quantity Mb. In other words, the second object B2 is an image representative of a player who acquired special rewards of which the quantity was the reference reward quantity Mb. As described above, the first embodiment displays the reward image Gw including the first object B1 corresponding to the provisional reward quantity Ma and the second object B2 corresponding to the reference reward quantity Mb. Therefore, the first embodiment has an advantage in that the player can easily compare the provisional reward quantity Ma with the reference reward quantity Mb. The reward image Gw in FIG. 21 represents respective numerical values of the provisional reward quantity Ma and the reference reward quantity Mb.

Each of the first object B1 and the second object B2 represents a moving object such as a car. The reward image Gw according to the first embodiment is an image representative of a race between the first object B1 and the second object B2. Specifically, when the reference reward quantity Mb is greater than the provisional reward quantity Ma, the second object B2 precedes the first object B1. When the provisional reward quantity Ma is greater than the reference reward quantity Mb, the first object B1 precedes the second object B2. Therefore, there is an advantage in that the player can visually and intuitively determine, in accordance with whether the first object B1 precedes the second object B2, whether the provisional reward quantity Ma is greater than the reference reward quantity Mb.

The display controller 76 controls a distance “d” between the first object B1 and the second object B2 in accordance with a difference δM (δM=|Ma−Mb|) between the provisional reward quantity Ma and the reference reward quantity Mb. The distance “d” is, for example, a distance between a front edge of the first object B1 and a front edge of the second object B2. Specifically, the display controller 76 increases the distance “d” between the first object B1 and the second object B2 as the difference δM is greater. The above configuration has an advantage in that the player can visually and intuitively confirm the difference δM between the provisional reward quantity Ma and the reference reward quantity Mb in accordance with the distance “d” between the first object B1 and the second object B2 that are on display.

The second region g2 of the reward image Gw represents the attached data “A” acquired together with the reference reward quantity Mb from the information manager 3. Specifically, the second region g2 represents the acquiring player a1, the acquisition facility a2, and the acquisition date and time a3.

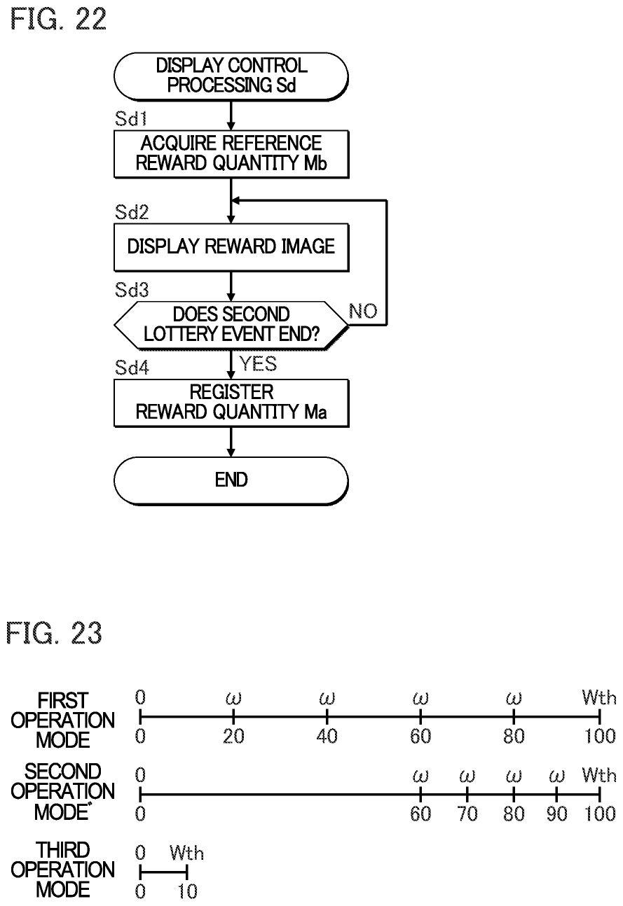

FIG. 22 is a flowchart illustrating a specific procedure of a processing (hereinafter referred to as a “display control processing”) Sd executed by the controller 11 with respect to the display of the reward image Gw. When the second lottery event is started, the display control processing Sd is executed in parallel with the progress of the second lottery event. Therefore, the reward image Gw on the display 22 is updated as needed in accordance with the progress of the second lottery event.

When the display control processing Sd is started, the reward quantity acquirer 75 acquires the current provisional reward quantity Ma from the storage device 12 and acquires the reference reward quantity Mb corresponding to the provisional reward quantity Ma from the information manager 3 (Sd1). Specifically, the reward quantity acquirer 75 transmits an information request including the provisional reward quantity Ma from the communicator 13 to the information manager 3. The information manager 3 selects, as the reference reward quantity Mb, the reward quantity Mc corresponding to the provisional reward quantity Ma in the information request from among the reward quantities Mc registered in the reward history data D, and transmits the reference reward quantity Mb to the game apparatus 1 that transmitted the information request. The reward quantity acquirer 75 acquires the reference reward quantity Mb received by the communicator 13 from the information manager 3.

The display controller 76 causes the display 22 to display the reward image Gw for comparing the provisional reward quantity Ma and the reference reward quantity Mb (Sd2). Specifically, the display controller 76 generates image data representative of the reward image Gw in which the first object B1 and the second object B2 are arranged with an interval “d” corresponding to the difference δM between the provisional reward quantity Ma and the reference reward quantity Mb. The display controller 76 provides the display 22 with the image data to cause the display 22 to display the reward image Gw.

The display controller 76 determines whether the second lottery event ends (Sd3). When the second lottery event does not end (Sd3: NO), the display controller 76 shifts the processing to step Sd2. In other words, the display controller 76 updates the reward image Gw. For example, when the provisional reward quantity Ma approaches the reference reward quantity Mb with an increase in the provisional reward quantity Ma, the display controller 76 decreases the interval “d” between the first object B1 and the second object B2. When the provisional reward quantity Ma is greater than the reference reward quantity Mb, the display controller 76 moves the first object B1 in front of the second object B2. In other words, a situation in which the first object B1 overtakes the second object B2 is displayed. As described above, the display controller 76 according to the first embodiment updates the reward image Gw in real time in accordance with the progress of the second lottery event.

When the second lottery event is ends (Sd3: YES), the reward quantity acquirer 75 registers the quantity Ma of the special rewards given to the player in this second lottery event (that is, a fixed value of the provisional reward quantity Ma) as a reward quantity Mc in the reward history data D (Sd4). Specifically, the reward quantity acquirer 75 transmits a registration request including both the provisional reward quantity Ma and the attached data “A” from the communicator 13 to the information manager 3. The attached data “A” includes information (an acquiring player a1, an acquisition facility a2, and an acquisition date and time a3) concerning the player played this second lottery event. The information manager 3 registers the provisional reward quantity Ma and the attached data “A” included in the registration request in the reward history data D. The display control processing Sd ends in response to transmission of the registration request (Sd4).

As described above, in the first embodiment, the reward image Gw is displayed to compare the provisional reward quantity Ma to be given to the player winning the special lottery with the reference reward quantity Mb given in a past game. Therefore, it is possible to provide the player with an incentive to aim at acquiring a large quantity of rewards. In the first embodiment, in particular, since the reference reward quantity Mb greater than the provisional reward quantity Ma is set, it is possible to provide the player with an incentive to aim at acquiring rewards of which the quantity is greater than the reference reward quantity Mb. Furthermore, since the reward image Gw is updated in parallel with the progress of the second lottery event, the player can confirm a change in the provisional reward quantity Ma in real time.

### Second Embodiment

A second embodiment according to the present disclosure will now be described. In each example illustrated below, elements having functions identical to those in the first embodiment are denoted by like reference signs as used in the descriptions in the first embodiment, and detailed explanations of such elements are omitted, as appropriate.

As described in the first embodiment, the first lottery event ends when the game object Qb attaches to the opposing member 364. In the second embodiment, a specific reward (hereinafter referred to as a “transitional reward”) is given to the player in an operation of the first lottery event. The transitional reward according to the second embodiment is an item for progressing the usual game favorably. For example, the transitional reward may be an item that increases a probability of winning the usual lottery. However, the transitional reward is not limited to the above examples.

FIG. 23 is a diagram for describing the giving of the transitional reward in the first lottery event. As illustrated in FIG. 23, the player selects one of operation modes before the start of the first lottery event. The operation modes each have first conditions. Each of the first conditions is a condition for giving the transitional reward to the player. The first conditions are different from each other. The operation modes may have second conditions respectively, instead of the first conditions. Each of the second conditions is a condition for changing the state of the moving member 362 to the drive state. The second conditions are different from each other. One of the operation modes may be selected by lottery in accordance with probabilities.

In the first operation mode and the second operation mode, a lottery (hereinafter referred to as an “intermediate lottery”) is carried out each time the cumulative reward quantity W reaches each of predetermined values (hereinafter referred to as “transitional values”) co until the cumulative reward quantity W reaches the threshold Wth. The intermediate lottery is an electronic lottery that determines, in accordance with probabilities, whether the player wins or loses. When the player wins the intermediate lottery, the player is given the transitional reward. On the other hand, when the player loses the transitional lottery, the player is not given the transitional reward. The larger the traditional value w at which the cumulative reward quantity W reaches, the more valuable the transitional reward (for example, a more effective item) to be given to the player who wins the intermediate lottery may be. Each time the cumulative reward quantity W reaches the traditional value ω, the transitional reward may be given to the player without carrying out the intermediate lottery. In FIG. 23, the threshold Wth is 100.

In the first operation mode, the transitional values ω are evenly distributed within a numerical range (0 to Wth) of the cumulative reward quantity W. In other words, the transitional values ω are distributed within the numerical range at determined intervals (for example, 20 intervals). On the other hand, in the second operation mode, the transitional values ω are unevenly distributed within a range close to the threshold Wth in the numerical range of the cumulative reward quantity W. For example, the transitional values w are distributed within a latter range from a middle point (Wth/2) to the threshold Wth in the numerical range. As will be understood from the above description, in the first operation mode, the transitional reward can be acquired in response to opportunities that occur evenly in a range from the start to the end of the first lottery event. On the other hand, in the second operation mode, the transitional reward can be acquired from a latter half of the first lottery event. As described above, the first lottery event can be realized in accordance with preferences or characteristics of the player.

In the third operation mode, the threshold Wth for the cumulative reward quantity W is smaller for the thresholds Wth for the first and second operation modes. Therefore, at an early stage after the start of the first lottery event, the cumulative reward quantity W may reach the threshold Wth and then the driving state may start in which the game object Qb may attach to the opposing member 364. However, in the third operation mode, all of the movable walls 322 are maintained in the ineffective state from the start of the first lottery event. In other words, the probability that the game object Qb enters the opening Ob of the circumferential wall portion 32 (that is, the probability that the first lottery event ends) is sufficiently higher than the probability that the game object Qb enters the opening Ob of the circumferential wall portion 32 in the first or second operation mode. As will be understood from the above description, the third operation mode is an operation mode attractive to a player who wants to win a prize at an early stage knowing the probability that the first lottery event will end.

### Modifications

Each of the embodiments described above can be variously modified. Specific modifications that may be applied to the above embodiments are described below. Two or more modifications selected from the following descriptions may be combined with one another as long as no conflict arises from such a combination.

### A: Modifications of Amusement Device 20

### Modification A1

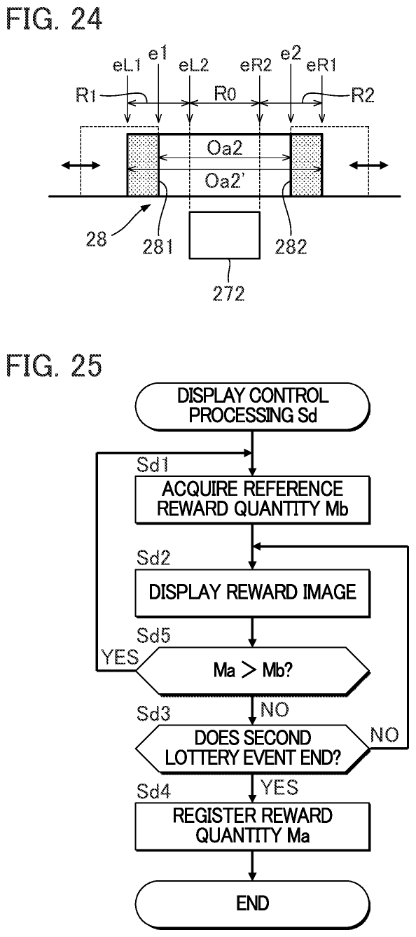

A configuration may be used in which the area of the opening Oa2, through which the game Qa1 falling from the second peripheral edge E2 passes, is adjustable. FIG. 24 is a diagram for describing an opening Oa2 in a modification A1. As illustrated in FIG. 24, an adjusting mechanism 28 that adjusts a size of the area of the opening Oa2 is arranged in the opening Oa2. The adjusting mechanism 28 includes a first adjusting body 281 and a second adjusting body 282. Each of the first adjusting body 281 and the second adjusting body 282 is a structure that partially closes the opening Oa2. The administrators of the game apparatus 1 can adjust the size of the area of the opening Oa2 by manually moving the first and second adjusting bodies 281 and 282. A detecting range R0 in FIG. 24 is a part of the second peripheral edge E2. Specifically, the detecting range R0 is a range corresponding to the detector 272 that detects the game object Qa1 falling from the second peripheral edge E2. For example, the detecting range R0 is determined such that the detecting range R0 overlaps with a portion of the detector 272 that detects the game object Qa1 in plan view.

On the other hand, the ranges R1 and R2 in FIG. 24 are ranges outside the detecting range R0. In other words, the range R1 and the range R2 are ranges that do not overlap with the part of the detector 272 that detect the game object Qa1 in plan view. The first adjusting body 281 is movable within the range R1. In other words, the peripheral edge “e1” of the first adjusting body 281 is movable within the range R1 from a left end “eL1” of an opening Oa2′ formed in the second wall portion 262 to a left end “eL2” of the detecting range R0. On the other hand, the peripheral edge “e2” of the second adjusting body 282 is movable within the range R2 from the right end “eR1” of the opening Oa2′ to the right end “eR2” of the detecting range R0. A range from the peripheral edge “e1” of the first adjusting body 281 to the peripheral edge “e2” of the second adjusting body 282 corresponds to the opening Oa2 that has been adjusted. As will be understood from the above description, the adjusting mechanism 28 adjusts the size of the area of the opening Oa2 in ranges in the second peripheral edge “e2.” The ranges in the second peripheral edge “e2” is outer ranges of the detecting range R0 corresponding to the detector 272. Therefore, the detecting range R0 is open regardless of positions of the first and second adjusting bodies 281 and 282. A mechanism such as a motor may be arranged to move the first adjusting body 281 or the second adjusting body 282 in accordance with instructions from the administrators. One of the first adjusting body 281 and the second adjusting body 282 may be omitted.

According to the above modification, the size of the area of the opening Oa2 is adjusted through which the game object Qb to be detected by the detector 272 passes. Therefore, frequency with which the usual lottery is carried out can be adjusted. The size of the area of the opening Oa2 is adjusted in the outer ranges of the detecting range R0 corresponding to the detector 272 in the second peripheral edge E2. Therefore, it is possible to reduce the probability that a result of adjustment by the adjusting mechanism 28 will excessively affect the detection of the game object Qb by the detector 272.

In the above description, a configuration is described in which the detector 272 overlaps with the opening Oa2, but the detector 272 may be arranged at a position not overlapping with the opening Oa2. In the above configuration, the game object Qb falling from the placing surface Fa1 onto the opening Oa2 is guided to the detector 272 through a predetermined path. As will be understood from the above example, the range that overlaps the detector 272 in plan view is an example of the detecting range R0. The detecting range R0 is comprehensively represented as the range corresponding to the detector 272, as described above. The above configuration has an advantage in that it is possible to enlarge an adjustable range of a width of the opening Oa2 to be adjusted by the adjusting mechanism 28.

### Modification A2

In each of the above embodiments, a configuration is described in which the movable table 24 moves in the circumferential direction, but the direction of the movement of the movable table 24 is freely selected. For example, the movable table 24 may move alternating between forward and backward (in the directions along the axis along the Y direction described above) relative to a player. In a configuration in which the movable table 24 moves alternating between forward and backward, the game objects Qa1 falling from the right or left peripheral edge on the fixed table 23 pass through the opening Oa2. As will be understood from the above description, a configuration may be used in which the game objects Qa1 falls from the second peripheral edge E2 that is in a direction (a second direction) intersecting the directions in which the movable table 24 moves on the placing surface Fa1.

### B: Modifications of First Lottery Device 30

### Modification B1

In each of the above embodiments, the state of the moving member 362 is changed to the drive state when the cumulative reward quantity W reaches the threshold Wth, but the conditions for changing the state of the moving member 362 to the drive state are not limited to the above example. For example, the state of the moving member 362 may be changed to the drive state in a condition in which a cumulative value of the number of times the game object Qb collides with the urging body 34 reaches a predetermined threshold. As will be understood from the above description, a configuration may be used in which the opposing member 364 approaches the game surface Fb when a predetermined condition is satisfied.

### Modification B2

In each of the above embodiments, the game object Qb moves away from the game surface Fb when the game object Qb collides with the protrusion 37 or the projection 38, but a configuration for moving the game object Qb away from the game surface Fb is not limited to the above example. For example, an ejection mechanism, which launches the game object Qb upward from the game surface Fb, may be arranged on the game surface Fb. The game surface Fb may vibrate in the vertical direction such that the game object Qb moves away from the game surface Fb in the vertical direction. In other words, the first lottery device 30 includes a mechanism to cause the game object Qb to move away from the game surface Fb. The projection 37 or 38 in each of the above embodiments, the ejection mechanism that launches the game object Qb, or a mechanism that vibrates the game surface Fb in the vertical direction is an example of a mechanism that causes the game object Qb to move away from the game surface Fb.

### Modification B3

In each of the above embodiments, the urging body 34 that strikes is the game object Qb is described, but a configuration for urging the game object Qb along the game surface Fb is not limited to the above example. For example, a configuration may be used that urges the game object Qb along the game surface Fb by pushing the game object Qb, or a configuration may be used that urges the game object Qb along the game surface Fb by magnetic force. The position of each of the urging bodies 34 may be freely selected. For example, the urging bodies 34 may be arranged along the outer periphery of the game surface Fb. For example, an array of the urging bodies 34 may constitute a wall portion.

### Modification B4

The first lottery event may include a plurality of stages. For example, in a first stage immediately after the first lottery event is started, as described in each of the above embodiments, one game object Qb is fed on the game surface Fb of the first lottery device 30. In a second stage, a plurality of game objects Qb are fed onto the game surface Fb of the first lottery device 30. For example, when the special rewards, of which the quantity is greater than a predetermined value, are given to the player in the second lottery event, the first stage is changed to the second stage. The reward image Gw described above may be displayed in the second lottery event after the change to the second stage. In other words, the reward image Gw may not be displayed in the first stage.

### Modification B5

In each of the above embodiments, a configuration is described in which the first lottery event ends in response to the game object Qb entering the opening Ob of the circumferential wall portion 32, but the position of the opening into which the game object Qb enters is not limited to the above example. For example, the first lottery event may end when the game object Qb enters an opening formed in the game surface Fb.

### Modification B6

In each of the above embodiments, the moving member 362 approaches the game surface Fb when the cumulative reward quantity W reaches the threshold Wth, but the movement of the moving member 362 is omitted. In other words, the moving member 362 may be maintained in a state in which the game object Qb is attachable to the opposing member 364 over a period of time from the start to the end of the first lottery event.

### Modification B7

In each of the above embodiments, a configuration is described in which the game object Qb attaches to the opposing member 364 by magnetic force, but a configuration for attaching the game object Qb to the opposing member 364 is not limited to the above example. For example, a drawing mechanism that attracts the game object Qb by suction, or a mechanism that adheres the game object Qb by an adhesive body formed of an adhesive material may be used as the opposing member 364.

### Modification B8

When a predetermined condition is satisfied, the first lottery event may be forced to end. For example, the first lottery event may be forced to end when the cumulative reward quantity W reaches a predetermined threshold, or when the first lottery event continues for a predetermined time. An upper limit may be set for the cumulative reward quantity W. For example, a configuration may be used in which, in a situation in which the cumulative reward quantity W reaches the upper limit, the cumulative reward quantity W is not increased even when the game object Qb collides with the urging body 34.

### Modification B9

In each of the above embodiments, a configuration is described in which one game object Qb is attached to the opposing member 364, but a plurality of game objects Qb may be attached to the opposing member 364. The detector 265 may detect the number of the game objects Qb attached to the opposing member 364. A configuration may be used that determines the number of the game object Qc to be used in the second lottery event in accordance with the number of the game objects Qb attached to the opposing member 364, or a configuration may be used that gives the player rewards of which the quantity varies in accordance with the number of the game objects Qb attached to the opposing member 364.

### C: Modifications of Second Lottery Device 40

### Modification C1

In each of the above embodiments, a configuration is described in which the first structure 41 of the second lottery device 40 includes two urging bodies 44 (the first urging body 441 and the second urging body 442), but the number of urging bodies 44 arranged in the first space C1 is not limited to two. In other words, a configuration may be used in which one urging body 44 is arranged in the first space C1 or a configuration may be used in which three or more urging bodies 44 are arranged in the first space C1.

### Modification C2

In each of the above embodiments, the urging bodies 44 that strike the game object Qb are described, but a configuration for urging the game object Qb is not limited to the above example. For example, a configuration may be used in which each urging body 44 pushes the game object Qb, or a configuration may be used in which each urging body 44 urges the game object Qb by magnetic force. A configuration may be used in which the rear wall portion 414 reciprocates along directions of approaching and separating from the second structure 42. The rear wall portion 414 functions as an urging body to urge the game object Qb toward the second structure 42 in a period of time in which the rear wall portion 414 approaches the second structure 42.

### Modification C3

In each of the above embodiments, the drive mechanism 422 rotates the lottery board 421 including the lottery member 45 and the circumferential wall portion 46, but only the circumferential wall portion 46 may be rotated while the lottery member 45 is fixed. In other words, rotating the circumferential wall portion 46 sequentially changes one of the states consisted of the communication state and the holding state to the other.

### Modification C4

The second lottery event may be forced to end when a predetermined condition is satisfied. For example, the second lottery event may be forced to end when the cumulative value of the rewards given to the player in response to the collision of the game object Qb with the urging body 44 reaches a predetermined threshold value, or when the second lottery event continues for a predetermined time. A configuration may be used that does not give rewards to the players even when the game object Qb collides with the urging body 44 in a situation in which the cumulative value of rewards in the second lottery event reaches a predetermined upper limit.

### D: Modifications of Image Display

### Modification D1

When the provisional reward quantity Ma is greater than the reference reward quantity Mb, the reference reward quantity Mb may be updated. FIG. 25 is a flowchart illustrating a specific procedure of the display control processing Sd in a modification D1. Similar to the first embodiment, the reward quantity acquirer 75 acquires the reference reward quantity Mb corresponding to the provisional reward quantity Ma from the information manager 3 (Sd1). Next, the display controller 76 causes the display 22 to display the reward image Gw for comparing the provisional reward quantity Ma and the reference reward quantity Mb (Sd2). The display controller 76 determines whether the current provisional reward quantity Ma is greater than the reference reward quantity Mb (Sd5). When the provisional reward quantity Ma is less than the reference reward quantity Mb (Sd5: NO), the display controller 76 determines whether the second lottery event ends, as in the first embodiment (Sd3). When the second lottery event does not end (Sd3: NO), the display controller 76 updates the reward image Gw (Sd2).

In parallel with the update of the reward image Gw described above, the provisional reward quantity Ma is increased by a predetermined value each time the game object Qb enters the lottery hole H corresponding to the lottery element La or the lottery element Lb in the second lottery event. When the provisional reward quantity Ma is greater than the reference reward quantity Mb (Sd5: YES), the process shifts to step Sd1. Therefore, the reward quantity acquirer 75 acquires the reference reward quantity Mb corresponding to the current provisional reward quantity Ma from the information manager 3 (Sd1). For example, the reference reward quantity Mb greater than the current provisional reward quantity Ma is acquired. In other words, the reward quantity acquirer 75 acquires a new reference reward quantity Mb greater than the reference reward quantity Mb acquired in the previous step Sd1. The display controller 76 causes the display 22 to display a reward image Gw for comparing the updated reference reward quantity Mb with the provisional reward quantity Ma (Sd2).

As described above, each time the provisional reward quantity Ma exceeds the reference reward quantity Mb, the new reference reward quantity Mb corresponding to the current provisional reward quantity Ma is acquired from among the reward quantities Mc registered in the reward history data D. Therefore, it is possible to continuously provide the player with an incentive to aim at acquiring rewards of which the quantity is greater than the reference reward quantity Mb.

In a configuration in which the reference reward quantity Mb is updated as needed as in the modification D 1, the reward quantity acquirer 75 may acquire, in advance, reward quantities Mc close to the provisional reward quantity Ma from the information manager 3. The reward quantities Mc acquired by the reward quantity acquirer 75 are stored in the storage device 12. The reward quantity acquirer 75 acquires one reward quantity Mc corresponding to the provisional reward quantity Ma from among the reward quantities Mc stored in the storage device 12 as the reference reward quantity Mb. According to the above configuration, it is possible to reduce the number of times communication is performed with the information manager 3.

### Modification D2

In each of the above embodiments, one reference reward quantity Mb corresponding to the provisional reward quantity Ma is acquired, but the reward quantity acquirer 75 may acquire reference reward quantities Mb corresponding to the provisional reward quantity Ma. For example, the reward quantity acquirer 75 acquires reference reward quantities Mb of which the number is a predetermined number, in ascending order, of the difference from the provisional reward quantity Ma, from the information manager 3 together with the attached data “A” corresponding the respective reference reward quantities Mb. The reward quantity acquirer 75 may acquire reference reward quantities Mb of which the number is variable, within a predetermined range including the provisional reward quantity Ma, from the information manager 3. The reward quantity acquirer 75 acquires the attached data “A” for each of the reference reward quantities Mb.

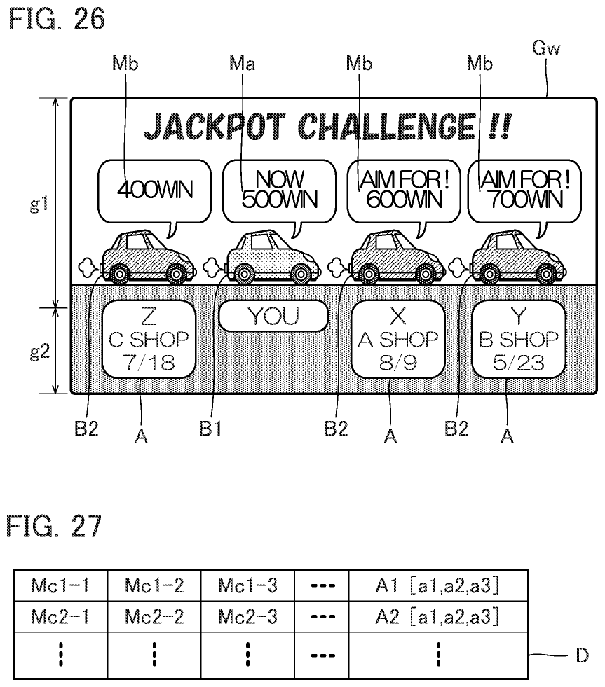

The display controller 76 causes the display 22 to display a reward image Gw for comparing the provisional reward quantity Ma and the reference reward quantities Mb. For example, as illustrated in FIG. 26, the display 22 displays a plurality of second objects B2 corresponding to the different reference reward quantities Mb respectively together with the first object B1 corresponding to the provisional reward quantity Ma. In the reward image Gw, information represented by the attached data “A” is displayed for each second object B2. In addition, the distance “d” between the first object B1 and the second object B2 corresponding to each reference reward quantity Mb is changed in accordance with the difference δM between the reference reward quantity Mb and the provisional reward quantity Ma. According to the above configuration, the plurality of reference reward quantities Mb corresponding to the provisional reward quantity Ma are displayed, which has a remarkable advantage of providing the player with an incentive to aim at acquiring a large quantity of rewards.

A configuration in which the reference reward quantities Mb are displayed in the reward image Gw as in the modification D2 may be included in a configuration in which at least one of the reference reward quantities Mb is greater than the provisional reward quantity Ma. The above configuration can provide the player with an incentive to aim at acquiring a larger quantity of rewards as compared to a configuration in which all of the reference reward quantities Mb are less than the provisional reward quantity Ma.

### Modification D3

FIG. 27 is a schematic diagram illustrating the reward history data D in a modification. In each of the above embodiments, the reward quantity Mc being the quantity of the rewards that were finally given to the player in a past second lottery event is registered in the reward history data D. In the reward history data D in a modification D3, several time series of the reward quantities Mc in each of the past second lottery events are registered. Specifically, for each of predetermined periods in a carrying out period of the second lottery event (hereinafter referred to as a “unit period”), the provisional reward quantity Ma for the unit period is registered in the reward history data D as the reward quantity Mc. In other words, the reward quantity Mc at each point in time within the period of the past second lottery event is registered in the reward history data D.

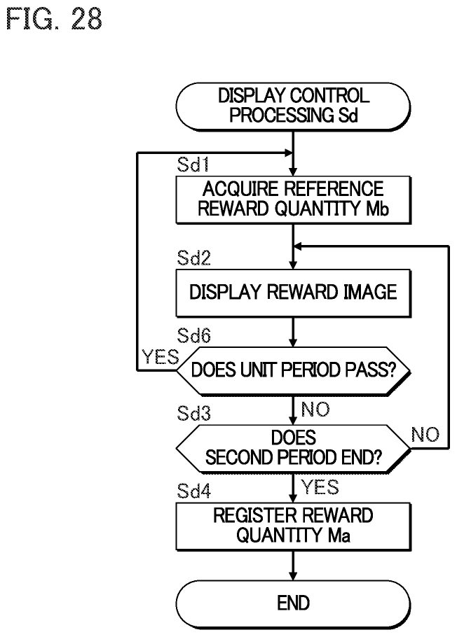

FIG. 28 is a flowchart illustrating a specific procedure of the display control processing Sd in the modification D3. Similar to the first embodiment, the reward quantity acquirer 75 acquires the reference reward quantity Mb corresponding to the provisional reward quantity Ma from the information manager 3 (Sd1). Specifically, in a first unit period for the second lottery event, the reward quantity acquirer 75 acquires a reward quantity Mc, which corresponds to the first unit period and which corresponds to the provisional reward quantity Ma, from among the time series of the reward quantity Mc registered in the reward history data D, as the reference reward quantity Mb. In addition, the display controller 76 causes the display 22 to display the reward image Gw for comparing the provisional reward quantity Ma and the reference reward quantity Mb (Sd2).

The reward quantity acquirer 75 determines whether a unit period passes from the end of an immediately preceding unit period (Sd6). Within the first unit period for the second lottery event, it is determined whether a unit period passes from the start of the second lottery event. When the unit period does not pass (Sd6: NO), the display controller 76 determines whether the second lottery event ends (Sd3) as in the first embodiment. When the second lottery event does not end (Sd3: NO), the display controller 76 updates the reward image Gw (Sd2).

On the other hand, when the unit period passes (Sd6: YES), the reward quantity acquirer 75 acquires the reference reward quantity Mb corresponding to the new unit period from the information manager 3 (Sd1). Specifically, the reward quantity acquirer 75 acquires the reward quantity Mc corresponding to the new unit period from among the time series of the reward quantity Mc registered in the reward history data D for the player corresponding to the already acquired reference reward quantity Mb, as the reference reward quantity Mb. In other words, the reward quantity acquirer 75 according to the modification D3 acquires the reward quantity Mc at a point of time within the period of the past second lottery event, as the reference reward quantity Mb. An operation (Sd2) in which the display controller 76 updates the reward image Gw in accordance with the reference reward quantity Mb acquired by the reward quantity acquirer 75 is the same as that in the first embodiment.

As described above, in the modification D3, the reward quantity Mc at a point in time within the period of the past second lottery event is acquired as the reference reward quantity Mb. Therefore, it is possible to provide the player with an incentive to aim at acquiring a large quantity of rewards at each point in time within the execution period of the second lottery event. In addition, the player cannot confirm the final reference reward quantity Mb (that is, a target that the player should aim for) before the end of the second lottery event. Thus, there is an advantage in that the player can maintain tension during the continuation of the second lottery event.

### Modification D4

The reward quantity acquirer 75 may acquire the reference reward quantity Mb corresponding to the provisional reward quantity Ma from among two or more reward quantities Mc, which satisfy a predetermined condition, of the reward quantities Mc registered in the reward history data D. For example, the reference reward quantity Mb may be selected from two or more reward quantities Mc, which correspond to the acquisition date and time A3 close to the present date and time, of the reward quantities Mc. Alternatively, for example, the reference reward quantity Mb may be selected from two or more reward quantities Mc, which correspond to a particular acquisition facility a2, of the reward quantities Mc. The reference reward quantity Mb may be acquired from two or more reward quantities Mc, which are registered for the player who starts the second lottery event, among the reward quantities Mc.

### Modification D5

A configuration may be used in which the first object B1 corresponding to the provisional reward quantity Ma is customizable to the player. For example, a value of ability of the first object B1 or an item to be added to the first object B1 may be changed in accordance with a degree of the progress of the second lottery event or with instructions from the player. The value of the ability of the first object B1 or the item related to the first object B1 is, for example, registered in the attached data “A.” A value of ability of the second object B2 or an item represented on the reward image Gw may be changed in accordance with the attached data “A.”

### Modification D6

Immediately after the second lottery event is started, the provisional reward quantity Ma may be sufficiently smaller than the reward quantity Mc actually given to a player in the past second lottery event. Therefore, display of the reward image Gw for comparing the provisional reward quantity Ma with the reference reward quantity Mb may be started at a stage at which a reasonable amount of time passes from the start of the second lottery event. For example, a configuration may be used in which the display of the reward image Gw (the display control processing Sd) is started at a stage at which the provisional reward quantity Ma exceeds a predetermined threshold.

### E: Other Modifications

### Modification E1

In each of the above embodiments, the game apparatus 1 is described that includes the first lottery device 30 that carries out the first lottery event and the second lottery devices 40 that each carries out the second lottery event. However, a configuration described for the first lottery device 30 or the second lottery device 40 are applicable to a game apparatus that does not have any lotteries. For example, the configuration of the first lottery device 30 or of the second lottery device 40 is applicable to a game apparatus that carries out a game such as a pinball game in which a game object Qb is repeatedly struck.

### Modification E2

The functions of the game apparatus 1 in each of the above embodiments are realized by cooperation of one or more processors constituting the controller 11 and programs (P0, P1, P2, P3) stored in the storage device 12. Each program may be provided in a form stored in a computer-readable recording medium and installed in a computer. The recording medium is, for example, a non-transitory recording medium. Although an optical recording medium (an optical disk) such as a compact disk read-only memory (CD-ROM) is one example of the recording medium, the recording medium may also include a recording medium of any known form, such as a semiconductor recording medium or a magnetic recording medium. The non-transitory recording medium includes any recording medium except for a transitory, propagating signal and does not exclude a volatile recording medium. The non-transitory recording medium may be a storage apparatus in a distribution apparatus that stores a computer program for distribution via a communication network.

### Supplemental Notes

For example, the present disclosure is understood as follows based on the above descriptions. In the following descriptions, reference signs in the drawings are denoted in parentheses for convenience in order to facilitate understanding of each aspect, but the present invention is not limited to the aspects illustrated in the drawings.

### Supplemental Note A1

A game apparatus (1) according to one aspect (a supplemental note A1) of the present disclosure includes a first space (C1) to which a game object (Qb) is supplied, a plurality of urging bodies (44) arranged spaced from each other in the first space (C1) and configured to urge the game object (Qb); and a second space (C2) for carrying out a first lottery using the game object (Qb), wherein a holding state changes to a communication state, the holding state is a state in which movement of the game object (Qb) from the first space (C1) to the second space (C2) is blocked, the communication state is a state in which the game object (Qb) urged by the plurality of urging bodies (44) moves from the first space (C1) to the second space (C2). According to the supplemental note A1, in the holding state, the movement of the game object (Qb) from the first space (C1) to the second space (C2) is blocked. Therefore, the game object (Qb) stays in the first space (C1) while being repeatedly urged by the plurality of urging bodies (44). On the other hand, in the communication state, the game object (Qb), which is urged by each of the urging bodies (44), moves from the first space (C1) to the second space (C2). Therefore, it is possible to carry out the first lottery with the game object (Qb) after a player sees an effective performance in which the game object (Qb) is repeatedly urged in the first space (C1) compared with a configuration in which the game object (Qb) is supplied to the second space (C2) without passing through the first space (C1).

“Game object (Qb)” is a movable three-dimensional object used in a game. A typical example of the game object (Qb) is a spherical object, but the game object (Qb) may be an object in a freely selected shape, such as a polyhedron or a disk.

“First space (C1)” is a space in which the plurality of urging bodies (44) are arranged. The game object (Qb), which is urged by each urging body (44), moves in the first space (C1) while sequentially colliding with an inner wall surface of the first space (C1) or each urging body (44). “Second space (C2)” is a space in which the first lottery is carried out by using the game object (Qb). Each of the first space (C1) and the second space (C2) is a space defined by a wall surface that restricts the movement of the game object (Qb), but they are not limited to an enclosed space.

“Urging” means applying force to the game object (Qb). A typical example of the urging body (44) is a striking mechanism (bumper) that strikes the game object (Qb) along a game surface, but it may be a mechanism that urges the game object (Qb) by magnetic force, for example. The urging body (44) is typically arranged on the game surface on which the game object (Qb) moves, but a place on which the urging bodies (44) is arranged is not limited to the game surface. For example, a configuration may be used in which the urging bodies (44) are arranged on an element facing the game surface (a configuration in which the urging bodies (44) do not contact the game surface).

### Supplemental Note A2

In a specific example (supplemental note A2) of the supplemental note A1, the plurality of urging bodies (44) include a first urging body (441) and a second urging body (442), the first urging body (441) is configured to urge the game object (Qb) toward a first angular range (Rc1) corresponding to a part of an entire circumference of the first urging body (441), the second urging body (442) being located in the first angular range, the second urging body (442) is configured to urge the game object (Qb) toward a second angular range (Rc2) corresponding to a part of a whole circumference of the second urging body (442), the first urging body (441) being located in the second angular range. According to the supplemental note A2, the first urging body (441) urges the game object (Qb) toward the range (Rc1) including the game object (Qb), and the second urging body (442) urges the game object (Qb) toward the range (Rc2) including the second urging body (442). Therefore, there is an advantage in that a state is easily maintained in which the game object (Qb) repeatedly reciprocates between the first urging body (441) and the second urging body (442).

### Supplemental Note A3

In a specific example (supplemental note A3) of the supplemental note A1 or the supplemental note A2, in the communication state, the game object (Qb) moves from the first space (C1) to the second space (C2) by passing through a communication port (461) communicating between the first space (C1) and the second space (C2), and in the holding state, passing of the communication port (461) by the game object (Qb) is blocked. According to the supplemental note A3, it is possible to change one of the communication state and the holding state to the other by a simple configuration that switches between a state in which the game object (Qb) is capable of passing through the communication port (461) and a state in which a passage through the communication port (461) is blocked.

The state in which the passage of the communication port (461) by the game object (Qb) is blocked is, for example, a state in which the first space (C1) and the second space (C2) are not communicated with each other, or a state in which an area of the communication port (461) is less than an area of the communication port (461) in the communication state.

### Supplemental Note A4

The game apparatus (1) according to a specific example (a supplemental note A4) of the supplemental note A3 includes a circumferential wall portion (46) surrounding the second space (C2) and a drive mechanism (422) that rotates the circumferential wall portion (46), and the communication port (461) is an opening of the circumferential wall portion (46). According to the supplemental note A4, the circumferential wall portion (46) with the communication port (461) rotates, it is possible to reduce the probability that the game object (Qb) excessively easily moves from the first space (C1) to the second space (C2). In other words, it is possible to allow the game object (Qb) to stay in the first space (C1) appropriately.

The drive mechanism (422) includes not only a mechanism that rotates only the circumferential wall portion (46) but also a mechanism that rotates a lottery member (45) in which the circumferential wall portion (46) is arranged (a configuration in which the circumferential wall portion (46) rotates together with the lottery member (45)).

### Supplemental Note A5

The game apparatus (1) according to a specific example (a supplemental note A5) of any one of the supplemental notes A1 to A4 further includes a supply path (Fd) for moving the game object (Qb) from the second space (C2) to the first space (C1). According to the supplemental note A5, the game object (Qb) moves from the first space (C1) to the second space (C2) in the communication state, and then moves from the second space (C2) to the first space (C1). Therefore, it is possible to alternate between the holding of the game object (Qb) in the first space C1 and the first lottery using the game object (Qb) in the second space C2.

A configuration that “moves the game object (Qb) from the second space (C2) to the first space (C1)” includes not only a configuration that moves a single game object (Qb) from the second space (C2) to the first space (C1), but also a configuration that discharges the game object (Qb) from the second space (C2) and supplies a game object (Qb) different from the discharged game object (Qb) to the first space (C1), the type of the different game object (Qb) is the same as the type of the discharged game object (Qb) (a configuration in which a game object (Qb) is switched between the second space (C2) and the first space (C1)). The latter configuration is also translated into a configuration in which the game object (Qb) is pseudo-moved from the second space (C2) to the first space (C1).

### Supplemental Note A6

In a specific example (supplemental note A6) of the supplemental note A5, the first lottery selects one of a plurality of lottery elements (L) including a first lottery element (La, Lb) and a second lottery element (Lc), the game apparatus further comprising a controller (74) configured to: when the first lottery (La, Lb) selects the first lottery element, move the game object (Qb) from the second space (C2) to the first space (C1) through the supply path (Fd) and increase one or more rewards to be given to a player, and when the first lottery selects the second lottery element (Lc), give at least one reward to the player. According to the supplemental note A6, the rewards are increased each time the first lottery element (La, Lb) is selected by the first lottery. Therefore, it is possible to provide the player with expectation of the rewards increasing in accordance with movement of the game object (Qb) from the second space (C2) to the first space (C1). The quantity (unit quantity) of rewards that increases when the first lottery element (La, Lb) is selected is typically a fixed value, but it may be a variable value.

### Supplemental Note A7

In a specific example (supplemental note A7) of any one of the supplemental notes A1 to A6, a second lottery to determine by lottery whether to restart the first lottery in accordance with a result of the first lottery is started in a third space (C0). According to the supplemental note A7, the second lottery is started in a third space (C0) in accordance with a result of the first lottery in the second space (C2). The second lottery determines by lottery whether to restart the first lottery. Therefore, it is possible to realize various lotteries including the first lottery and the second lottery.

### Supplemental Note A8

The game apparatus (1) according to a specific example (a supplemental note A8) of any one of the supplemental notes A1 to A7 further includes a lottery member (45) in the second space (C2), the lottery member (45) includes lottery holes (H), each of the lottery holes (H) is a lottery hole into which the game object (Qb) is enterable, the first lottery is an operation of causing the game object (Qb) to enter one of the lottery holes (H).

### Supplemental Note A9

In a specific example (supplemental note A9) of the supplemental note A8, the lottery member (45) and a circumferential wall portion (46) are formed to be integral. According to the supplemental note A9, it is possible to move the lottery member (45) and the circumferential wall portion (46) together.

### Supplemental Note A10

A game apparatus (1) according to one aspect (supplemental note A10) of the present disclosure includes a first structure (41) including a first space (C1) to which a game object (Qb) is supplied, the first structure (41) including a plurality of urging bodies (44), the plurality of urging bodies (44) are arranged spaced from each other in the first space (C1) and configured to urge the game object (Qb), and a second structure (42) forming a second space (C2) for carrying out a first lottery using the game object (Qb), wherein a holding state changes to a communication state, the holding state is a state in which movement of the game object (Qb) from the first space (C1) to the second space (C2) is blocked, the communication state is a state in which the game object (Qb) urged by the plurality of urging bodies (44) moves from the first space (C1) to the second space (C2). In the supplemental note A10, in the holding state, the movement of the game object (Qb) from the first space (C1) to the second space (C2) is blocked. Accordingly, the game object (Qb) stays in the first space (C1) while being repeatedly urged by the plurality of urging bodies (44). On the other hand, in the communication state, the game object (Qb), which is urged by each of the urging bodies (44), moves from the first space (C1) to the second space (C2). Therefore, it is possible to carry out the first lottery with the game object (Qb) after a player sees an effective performance in which the game object (Qb) is repeatedly urged in the first space (C1) compared with a configuration in which the game object (Qb) is supplied to the second space (C2) without passing through the first space (C1).

### Supplemental Note B

There has been conventionally proposed in the art techniques for displaying a ranking of scores obtained by game players. For example, Japan Patent No. 6280093 discloses a configuration for displaying a ranking of scores obtained by each of game players in the past.

In addition, it has been conventionally proposed that a lottery game in which a quantity of rewards to be given to a player winning a lottery process (hereinafter referred to as a “reward quantity”) varies moment by moment in accordance with progress of the game. In the lottery game, displaying a ranking of the reward quantity acquired in the past by each of players cannot provide players with a sufficient incentive to aim at acquiring a large quantity of rewards. In view of the circumstances described above, an object of the present disclosure is to provide players an incentive to aim at acquiring a large quantity of rewards.

### Supplemental Note B1

A game apparatus (1) according to one aspect (supplemental note B1) of the present disclosure includes a reward quantity controller (74) configured to change, in accordance with progress of a game, a first reward quantity (Ma) to be given to a player who wins a lottery process, a reward quantity acquirer (75) configured to acquire a second reward quantity (Mb) corresponding to the first reward quantity (Ma) from among reward quantities (Mc) given in a past game, and a display controller (76) configured to cause a display (22) to display a reward image (Gw) for comparing the first reward quantity (Ma) and the second reward quantity (Mb). According to the supplemental note B1, the reward image is displayed that was used for comparing the first reward quantity (Ma) to be given to the player who wins the lottery process and the second reward quantity (Mb) given in the past game. Therefore it is possible to provide the player with an incentive to aim at acquiring a large quantity of rewards.

The “lottery process” may be either a physical lottery using a lottery mechanism (for example, a roulette wheel) or an electronic lottery realized by an arithmetic apparatus carrying out arithmetic operations (for example, a video slot machine).

A specific example of a configuration in which the first reward quantity (Ma) is changed in accordance with the progress of the game is a configuration in which the first reward quantity (Ma) is increased or decreased in accordance with a state of a game object (Qb) used in the lottery process (in particular, a physical lottery). For example, in a lottery process in which a game object (Qb) enters one of lottery holes (H), the first reward quantity (Ma) is increased or decreased in accordance with a lottery hole (H) into which the game object (Qb) entered among the lottery holes (H). Alternatively, for example, in a lottery process in which the game object (Qb) is rolled on a surface of a playing surface on which a plurality of elements (for example, bumpers that each strike the game object (Qb)) are arranged, the first reward quantity (Ma) is increased by a predetermined quantity each time the game object (Qb) collides with each element.

The “reward quantities (Mc)” are typically reward quantities previously given to unspecified players, but they may be reward quantities previously given to a specific player playing the game.

The “to acquire a second reward quantity (Mb) corresponding to the first reward quantity (Ma) from among reward quantities (Mc)” means that the reward quantity to be selected as the second reward quantity (Mb) from among the reward quantities (Mc) varies in accordance with the first reward quantity (Ma). For example, a configuration may be used in which a reward quantity closest to the first reward quantity (Ma) among the reward quantities (Mc) is acquired as the second reward quantities (Mb).

“Reward image (Gw)” is an image by which the player can determine whether the first reward quantity (Ma) is greater than the second reward quantity (Mb). An example of the reward image (Gw) is an image including a first object (B1) corresponding to the first reward quantity (Ma) and a second object (B2) corresponding to the second reward quantity (Mb), or an image including numerical values for each of the first reward quantity (Ma) and the second reward quantity (Mb).

### Supplemental Note B2

In a specific example (supplemental note B2) of the supplemental note B1, the display controller (76) causes the display (22) to display the reward image (Gw) in parallel with the progress of the game, and updates the reward image (Gw) in accordance with the progress of the game. According to the supplemental note B2, the reward image (Gw) is displayed and updated in parallel with the progress of the game. Therefore, the player can confirm a change in the first reward quantity (Ma) in real time.

### Supplemental Note B3

In a specific example (supplemental note B3) of the supplemental note B1 or the supplemental note B2, the reward image (Gw) includes the first object (B1) corresponding to the first reward quantity (Ma) and the second object (B2) corresponding to the second reward quantity (Mb). According to the supplemental note B3, the reward image (Gw) is displayed that includes the first object (B1) corresponding to the first reward quantity (Ma) and the second object (B2) corresponding to the second reward quantity (Mb). Therefore, there is an advantage in that the player can easily compare the first reward quantity (Ma) and the second reward quantity (Mb). “Object” is freely selected element that constitutes the reward image (Gw). For example, an example of the object is a character.

### Supplemental Note B4

In a specific example (supplemental note B4) of the supplemental note B3, the reward image (Gw) is an image representative of a race between the first object (B1) and the second object (B2), the second object (B2) precedes the first object (B1) when the second reward quantity (Mb) is greater than the first reward quantity (Ma). According to the supplemental note B4, the reward image (Gw) is displayed that is presentative of the race between the first object (B1) corresponding to the first reward quantity (Ma) and the second object (B2) corresponding to the second reward quantity (Mb). Therefore, there is an advantage in that the player can visually and intuitively determine, in accordance with whether the first object (B1) precedes the second object (B2), whether the first reward quantity (Ma) is greater than the second reward quantity (Mb).

### Supplemental Note B5

In a specific example (supplemental note B5) of the supplemental note B4, the display controller (76) controls a distance (d) between the first object (B1) and the second object (B2) in accordance with a difference (δM) between the first reward quantity (Ma) and the second reward quantity (Mb). The supplemental note B5 has an advantage in that the player can visually and intuitively determine the difference (δM) between the first reward quantity (Ma) and the second reward quantity (Mb) in accordance with the distance (d) between the first object (B1) and the second object (B2).

### Supplemental Note B6

In a specific example (supplemental note B6) of any one of the supplemental note B1 to the supplemental note B5, the reward quantity acquirer (75) acquires a reward quantity greater than the first reward quantity (Ma) from among the reward quantities (Mc) as the second reward quantity (Mb). According to the supplemental note B6, the second reward quantity (Mb) greater than the first reward quantity (Ma) is set. Therefore, it is possible to provide the player with an incentive to aim at acquiring rewards of which the quantity is greater than the second reward quantity (Mb).

### Supplemental Note B7

In a specific example (supplemental note B7) of the supplemental note B6, the reward quantity acquirer (75) acquires two or more second reward quantities (Mb) including the second reward quantity (Mb), and the reward image (Gw) is an image for comparing the first reward quantity (Ma) and the two or more second reward quantities (Mb), at least one second reward quantity (Mb) among the two or more second reward quantities (Mb) is greater than the first reward quantity (Ma). According to the supplemental note B7, the two or more second reward quantities (Mb) are acquired. Therefore, there is a significant advantage in that it is possible to provide the player with an incentive to aim at acquiring many rewards. Furthermore, the at least one second reward quantity (Mb) among the two or more second reward quantities (Mb) is greater than the first reward quantity (Ma). Therefore, it is possible to provide the player with an incentive to aim at acquiring many rewards compared to a configuration in which all of the two or more second reward quantities (Mb) are less than the first reward quantity (Ma).

### Supplemental Note B8

In a specific example (supplemental note B8) of the supplemental note B6 or the supplemental note B7, the reward quantity acquirer (75) acquires the second reward quantity (Mb) from the reward quantities (Mc) when the first reward quantity (Ma) is greater than the second reward quantity (Mb). In the supplemental note B8, the second reward quantity (Mb) is updated when the first reward quantity (Ma) is greater than the second reward quantity (Mb). Therefore, it is possible to continuously provide the player with an incentive to aim at acquiring rewards of which the quantity is greater than the second reward quantity (Mb).

### Supplemental Note B9

In a specific example (supplemental note B9) of any one of the supplemental note 1 to the supplemental note B8, the reward quantity acquirer (75) acquires a reward quantity at a point of the middle of the past game as the second reward quantity (Mb). In the supplemental note B9, the reward quantity at a point of the middle of the past game, is acquired as the second reward quantity (Mb). Therefore, it is possible to provide the player with an incentive to aim at acquiring many rewards at each point in the progress of the game.

### Supplemental Note B10

A method of operating a game apparatus according to one aspect (supplemental note B10) of the present disclosure includes changing (Sc5, Sc8), in accordance with progress of a game, a first reward quantity (Ma) to be given to a player who wins a lottery process, acquiring a second reward quantity (Mb) corresponding to the first reward quantity (Ma) from among reward quantities (Mc) given in a past game, and causing a display (22) to display a reward image (Gw) for comparing the first reward quantity (Ma) and the second reward quantity (Mb).

### Supplemental Note B11

A program (P3) according to one aspect (supplemental note B11) of the present disclosure causes one or more processors to function as a reward quantity controller (74) configured to change, in accordance with progress of a game, a first reward quantity (Ma) to be given to a player who wins a lottery process, a reward quantity acquirer (75) configured to acquire a second reward quantity (Mb) corresponding to the first reward quantity (Ma) from among reward quantities (Mc) given in a past game, and a display controller (76) configured to cause a display (22) to display a reward image (Gw) for comparing the first reward quantity (Ma) and the second reward quantity (Mb).

### DESCRIPTION OF REFERENCE SIGNS

1 . . . game apparatus, 11 . . . controller, 12 . . . storage device, 13 . . . communicator, 2 . . . communication network, 3 . . . information manager, 20 . . . amusement device, 21 . . . operation panel, 211 . . . operation elements, 212 . . . receiver, 213 . . . payout portion, 22 . . . display, 23 . . . fixed table, 24 . . . movable table, 251, 252 . . . feeder, 26 . . . support structure, 261 . . . first wall portion, 262 . . . second wall portion, 263 . . . third wall portion, 264 . . . fourth wall portion, 271, 272 . . . detector, 28 . . . adjusting mechanism, 281 . . . first adjusting mechanism, 282 . . . second adjusting mechanism, 30 . . . first lottery device, 31 . . . game mechanism, 32 . . . circumferential wall portion, 321 . . . fixed wall, 322 . . . movable wall, 33 . . . drive mechanism, 34 . . . urging body, 341 . . . main body, 342 . . . detector, 343 . . . striker, 35 . . . feeding mechanism, 36 . . . detecting mechanism, 361 . . . support, 362 . . . moving member, 363 . . . drive mechanism, 364 . . . opposing member, 365 . . . detector, 37 . . . protrusion. 38 . . . protrusion, 311 . . . rotating body, 312 . . . base, 40 . . . second lottery device, 41 . . . first structure, 411 . . . bottom portion, 412 . . . first side wall portion, 413 . . . second side wall portion, 414 . . . rear wall portion, 441 . . . first urging body, 442 . . . second urging body, 42 . . . second structure, 421 . . . lottery board, 422 . . . drive mechanism, 45 . . . lottery member, 451 . . . lottery portion, 452 . . . display, 46 . . . circumferential wall portion, 461 . . . communication port, 462 . . . introduction passage, 43 . . . transport structure, 431 . . . transport plate, 432 . . . ejection mechanism, 433 . . . collision portion, 61 . . . first travel path, 62 . . . second travel path, 63 . . . fake path, 631 . . . path member, 632 . . . light emitter, 64 . . . first storage container, 65 . . . second storage container, 71 . . . reward giver, 72 . . . lottery controller, 73 . . . first controller, 74 . . . second controller, 75 . . . reward quantity acquirer, 76 . . . display controller.

What is claimed is:

1. A game apparatus comprising:
a first space to which a game object is supplied;
a plurality of urging bodies arranged spaced apart from each other in the first space and configured to urge the game object; and
a second space for carrying out a first lottery using the game object,
wherein a holding state changes to a communication state, the holding state is a state in which movement of the game object from the first space to the second space is blocked, the communication state is a state in which the game object urged by the plurality of urging bodies moves from the first space to the second space.

2. The game apparatus according to claim 1, wherein:
the plurality of urging bodies includes a first urging body and a second urging body,
the first urging body is configured to urge the game object toward a first angular range corresponding to a part of an entire circumference of the first urging body, the second urging body being located in the first angular range,
the second urging body is configured to urge the game object toward a second angular range corresponding to a part of an entire circumference of the second urging body, the first urging body being located in the second angular range.

3. The game apparatus according to claim 1, wherein:
in the communication state, the game object moves from the first space to the second space by passing through a communication port communicating between the first space and the second space, and
in the holding state, passing of the communication port by the game object is blocked.

4. The game apparatus according to claim 3, further comprising:
a circumferential wall portion surrounding the second space; and
a drive mechanism that rotates the circumferential wall portion,
wherein the communication port is an opening of the circumferential wall portion.

5. The game apparatus according to claim 1, further comprising:
a supply path for moving the game object from the second space to the first space.

6. The game apparatus according to claim 5, wherein:
the first lottery selects one of a plurality of lottery elements including a first lottery element and a second lottery element,
the game apparatus further comprising a controller configured to:
when the first lottery selects the first lottery element, move the game object from the second space to the first space through the supply path and increase rewards to be given to a player, and
when the first lottery selects the second lottery element, give at least one reward to the player.

7. The game apparatus according to claim 1, wherein a second lottery is started in a third space in accordance with a result of the first lottery, the second lottery determining by lottery whether to restart the first lottery.

8. The game apparatus according to claim 1, further comprising a lottery member in the second space, the lottery member having lottery holes,
wherein:
each of the lottery holes is a lottery hole in which the game object is enterable,
the first lottery is an operation of causing the game object to enter one of the lottery holes.
